(19) United States
(12) Patent Application Publication
(10) Pub. No.: US 2003/0169766 A1
(43) Pub. Date: Sep. 11, 2003

(54) Communications apparatus and network system

(76) Inventor: Jun Ogawa, Kawasaki (JP)

Correspondence Address: KATTEN MUCHIN ZAVIS ROSENMAN, 575 MADISON AVENUE, NEW YORK, NY, 10022-2585, US

(21) Appl. No.: 10/366,172

(22) Filed: Feb. 13, 2003

(30) Foreign Application Priority Data
Mar. 5, 2002 (JP) 2002-058260

(51) Int. Cl. H04J 3/16

(52) U.S. Cl. 370/466; 370/401

(57) ABSTRACT

A communication apparatus allows access to be gained from a global address network to a private address network. An address converter assigns unique names (e.g., PC-B.home-a.com as an FQDN) to respective nodes (terminals A through D) belonging to the private address network and manages the nodes under the unique names. If there is an inquiry about a certain node from a certain node belonging to the global address network or another private address network, then the address converter acquires a corresponding private address (e.g., 192.168.0.2 if the inquiry is about PC-B.home-a.com) and notifies the node of the acquired private address. DNS servers for private address networks which do not belong to a tree of DNS servers on the global address network are provided in association with the respective private address networks, and are accessible from the global address network. Therefore, a name resolution for a private address can be achieved via the global address network.

### BACKGROUND OF THE INVENTION

1. Field of the Invention

The present invention relates to a communications device and a network system, and more particularly to a communications device and a network system which have a global address network whose nodes have respective unique addresses, a private address network having addresses which are not unique, and an address converter for converting addresses for transmitting data between the global address network and the private address network.

2. Description of the Related Art

IP addresses used for Internet communications are placed under international management. Users who intend to establish Internet communications need to have IP addresses (also called official IP addresses, hereinafter referred to as global IP addresses) and domain names that are unique on the Internet, allocated and registered by an international organization which has unified control over IP addresses or a managing organization commissioned thereby (in Japan, Japan Network Information Center (JPNIC) or provider approved as its acting agents). Therefore, anybody who has not acquired a global IP address cannot, and is not supposed to, establish Internet communications.

On networks such as LANs (Local Area Networks) which do not make Internet communications, the users can use any desired IP addresses (IP addresses other than global IP addresses will hereinafter be referred to as unofficial IP addresses.) According to RFCs (Requests For Comments) provided by the IETF (International Engineering Task Force) which is an organization for establishing standards of the Internet technology, it is recommended that a terminal on a LAN which does not connect to the Internet have an IP address having a certain number capable of identifying itself as not being a global IP address, i.e., an unofficial address hereinafter referred to as a private IP address, so that no problem will arise if the terminal with the private IP address should connect to the Internet by a mistake (as described in detail later on).

With the rapid growth in recent years of Internet communications, the number of unassigned global IP addresses is running out, resulting in a possible failure to meet demands for the allocation of global IP addresses to networks such as in companies and local governments that need a large number of IP addresses. To protect against such a shortage of global IP addresses, it has become customary to use private IP addresses (or unofficial IP addresses) in LANs in corporations and use global IP addresses for Internet communications with external networks.

In view of a quick increase in the number of LANs (private networks) and a widespread use of Internet communications, there are growing needs for LANs which have been constructed on private IP addresses solely for the purpose of achieving connections within the LANs to connect to other networks which have also been constructed on private IP addresses. However, these demands suffer the following problems: A private IP address includes a network number to which a fixed number is assigned, and hence has a relatively small range available for a number for use as the private IP address itself. For this reason, different networks may possibly share one private IP address. When different networks which may possibly have one private IP address in common are directly connected to each other without the intermediary of the global Internet, it is desirable not to change private IP addresses assigned to individual terminals and data set in servers which handle addresses. Accordingly, there has been a demand for an IP address converting device which makes it possible to connect different networks which use unique private IP addresses to each other without the need for changing the environments of those networks which have already been put into service.

(1) Structure of IP Addresses:

As well known in the art, an IP address used for Internet communications in conformity with the TCP/IP protocol is made up of 32 bits assigned to an address part for identifying a network (hereinafter referred to as a network number) and an address part for identifying an individual host (terminal) in the network (hereinafter referred to as a host number). Some corporate networks are large-scale networks having a large number of hosts, and a large number of networks (local networks) each having a small number of hosts are located in a wide geographical region. Therefore, the number of figures that make up a network number varies depending on the scale and structure of the network. The term “class” used in connection with a network represents how many figures are used in a network number assigned to the network.

FIG. 21 of the accompanying drawings shows the structures of IP addresses in different classes, i.e., class A, class B, and class C. As shown in FIG. 21, an IP address in class A comprises a first bit of “0”, next 7 bits representing a network number (denoted as a NW number in FIG. 21 and other figures), and remaining 24 bits representing a host number. The numerical values in parentheses in FIG. 21 indicate the number of bits used in network numbers and host numbers. An IP address in class B comprises first 2 bits of “10” according to the binary notation, next 14 bits representing a network number, and remaining 16 bits representing a host number. An IP address in class C comprises first 3 bits of “111” according to the binary notation, next 21 bits representing a network number, and remaining 8 bits representing a host number. Other classes such as class D, class E will not be described in detail below.

As shown in FIG. 21, 24 bits can be assigned to a host number in class A. Actually, it is not very often to allot a host number arbitrarily to a terminal in a network, but is customary to further hierarchize the network into subnetworks (hereinafter referred to as subnets.) A part of an IP address that is assigned to a subnet is referred to as a subnet number. A subnet number is expressed as a part of a host number. The relationship between a host number and a subnet number is shown in FIG. 21. The number of subnets contained in a network and the number of bits of a subnet number assigned to each subnet are optional. However, it is the most general to assign a unit of 8 bits to a subnet number as shown in FIG. 21.

It is the customary practice to divide a 32-bit IP address into four 8-bit groups, i.e., four numbers separated by periods, each of the four numbers being represented by the decimal notation. Each of the four decimal numbers, i.e., a number in a unit of 8 bits, is referred to as a figure. The numerical value of a bit or bits indicative of a class and that of a network number or a part thereof, which jointly make up the first 8 bits of the IP address, is expressed by the decimal notation. FIG. 22 of the accompanying drawings shows the range of numbers that are used in IP addresses in the classes according to the above IP address representation scheme. In class A, since the first bit is “0”, the first figure is in a numerical range from “0 to 127” (the actual range is from “0 to 126”.) The numerical values of figures will hereinafter be expressed by the decimal notation unless otherwise indicated.

In class B, since the first 2 bits are “10” according to the binary notation, the first figure is in a numerical range from “128 to “191”. In class C, the first figure is in a numerical range from “192 to 223”, not “192 to 255” because of class D (the first 4 bits are “1110” according to the binary notation) and class E (the first 5 bits are “11110” according to the binary notation.) Each of the three figures other than the first figure is in a numerical range from “0 to 255” that can be used for a network number or a host number (subnet number). An IP address in each class is expressed by “10.H.H.H” (for class A) according to the decimal notation as shown on the right side in FIG. 22. “H” refers to a host number and is represented by a number in the range from 0 to 255. Therefore, the number in the first figure of an IP address should be able to identify the class of the IP address.

The above IP address structure is applicable to both global IP addresses and private IP addresses. RFC1597 provided by the IETF recommend the use of a private IP address that can be identified as not being a global IP address. FIG. 23 of the accompanying drawings shows numerals of private IP addresses according to RFC1597. In FIG. 23, numerical ranges that are shown hatched can be used for private IP addresses. For example, the first figure in a private IP address in class A is limited to “10” according to the decimal notation, and numbers that can be used in the first and next figures in private addresses in classes B, C are limited as shown in FIG. 23. In class C, since each of the first two figures in a private IP address is limited to one number, the number of network numbers that can be used arbitrarily and the number of host numbers that can be used arbitrarily are 256 each.

The probability that an identical address will be used by different networks is greatly affected by the number of hosts in the networks, and cannot be determined as higher for a certain class than for another. However, since private IP addresses in any classes contain certain numerical values that cannot be used freely, a choice of numbers available for private IP addresses is relatively narrow, resulting in an increase in the possibility that an identical private IP address will be used by different networks. Consequently, when communications are to be sent between two networks having private IP addresses assigned uniquely thereto, the users should be aware that an identical address could possibly be present in the networks.

(2) Process of Connecting a Terminal with a Private IP Address to the Internet:

A conventional process of establishing a connection between terminals on two respective networks which use private IP addresses will be described below. According to the conventional process, a network using private IP addresses is connected to another network through the global Internet for sending communications to the other network. The conventional process is disclosed in Japanese laid-open patent publication No. 9-233112, and will be described on the assumption that a terminal disclosed in the above publication is a terminal (including a server) having a global IP address.

FIG. 24 of the accompanying drawings shows in block form an internetwork environment illustrated in FIG. 1 of the above publication, with some descriptions added thereto according to the publication. The term “official IP address” described in the publication is the same as the term “global IP address” referred to in this description. In the description of FIG. 24, the term “official IP address” will be used according to the description in the publication. The term “unofficial IP address” described in the publication is the same as the term “unofficial IP address” in the present description (wider in meaning than a private IP address), and will be used in the description of FIG. 24.

Only unofficial IP addresses are assigned to respective terminals 225 on a private network 202 shown in FIG. 24. If an individual terminal 225 is referred to, it will be described as a terminal A. It is assumed that a terminal A is to connect to a server 205 (hereinafter referred to as a server S) outside of the private network 202.

The terminal A which serves as a transmission source is aware of the domain name of the transmission destination, i.e., the server S, and inquires the IP address thereof based on the domain name, which is assumed to be “ftp.out.co.jp”, of the server S. A router 224 (hereinafter referred to as a router K) connected to the terminal A asks an internetwork 201 for the IP address of a terminal (including a server) having the above domain name according to a known process through a router 203 (hereinafter referred to as a router N) connected to the internetwork 201. As a result, the internetwork 201 answers the unofficial IP address, which is assumed to be “150.96.10.1” and abbreviated as “IP-D”, of the server S having the above domain name.

If it is assumed that there is no address converter 204 and the router N sends the unofficial IP address “150.96.10.1” through the router K to the terminal A, then the terminal A will subsequently transmit packets with the above IP address set in the destination address in those packets. In the example shown in FIG. 24, however, since a terminal B on the private network 202 has exactly the same unofficial IP address as the above address IP-D, if the terminal A sets the destination address to “150.96.10.1”, then the packets may possibly be transmitted from the terminal A to the terminal B.

To solve the above problem, an address converter 204 connected between the private network 202 and the router N as shown in FIG. 24 converts addresses. Specifically, when the address converter 204 receives an IP packet containing the domain name of the server S as the destination address from the terminal A, the address converter 204 asks the internetwork 201 for the IP address of the server S, and selects an unofficial IP address, which is assumed to be “159.99.30.1” and abbreviated as “IP-C”, that is effective as an unofficial address of the server S only in the private network 202 and is not presently used in the private network 202, and sends the selected unofficial IP address “IP-C” to the terminal A. The terminal A will subsequently transmit packets with the selected unofficial IP address “IP-C” set in the IP address of the destination.

When the unofficial IP address “150.96.10.1” of the server S is answered from the internetwork 201 in reply to the above inquiry, the address converter 204 converts the destination IP address “IP-C” in the packets transmitted from the terminal A into “IP-D” based on stored data of the association between the unofficial IP address “IP-D” and the official IP address “IP-C”, and sends the packets with the converted IP address “IP-D” to the internetwork 201.

The terminal A is assigned an unofficial IP address, which is assumed to be “154.100.10.1” and abbreviated as “IP-A”. The terminal A thus sets the source address to “IP-A” in packets to be transmitted. Since unofficial IP addresses are invalid in the internetwork 201, the address converter 204 acquires an official IP address, which is assumed to be “150.47.1.1” and abbreviated as “IP-E”, for the terminal A according to a known process, and stores data of the association between the unofficial IP address “IP-A” and the official IP address “IP-E”. Subsequently, the address converter 204 will convert “IP-A” set in the source IP address in packets transmitted from the terminal A to “IP-E”, and transmits the packets with the converted IP address “IP-E” as the source address.

When packets are to be transmitted from the server S to the terminal A, the server S sets the official IP address “IP-E” of the terminal A as the destination IP address in the packets. The address converter 204 converts the destination address “IP-E” in the packets received from the server S into “IP-A”, and sends the packets with the converted address “IP-A” to the private network 202. Therefore, even if the private network 202 includes a terminal 225 which has the same unofficial IP address as the official IP address “IP-E” of the destination, the packets will not be transmitted to that terminal 225.

(3) Method of Converting IP Addresses:

The conventional process of converting addresses at the time a terminal on a network using private IP addresses (a private network) makes a connection to the Internet has been described above with respect to a connection procedure. Now, a conventional method of converting IP addresses will be described below.

In the above example, the address converter is used to convert addresses. One known general address conversion process is to have a router or a firewall server incorporate a function known as NAT (Network Address Translation) or IP masquerade (or multi-NAT.)

NAT: First, NAT will be described below. NAT refers to an address conversion process described in RFC1631 and is a function for converting private IP addresses and global IP addresses. Many inexpensive routers have the NAT function as one of its features. FIG. 25 of the accompanying drawings is illustrative of the NAT function, and shows a network configuration and a model in which IP addresses are used. In FIG. 25, it is assumed that a plurality of terminals 321 (also referred to as a terminal A, etc. if a certain individual terminal is mentioned) connected to a private network (hereinafter referred to as a LAN) 320 are assigned respective private IP addresses as shown.

If a terminal A connected to the LAN 320 and having a private IP address “10.1.1.10” is to establish Internet communications, or specifically to connect to a terminal on another network (not shown) through a global network (the Internet) 380, then the terminal A acquires a global IP address, e.g., “20.1.1.10”, for use on the Internet from a router 310.

The router 310 has a NAT function which converts the private IP address “10.1.1.10” of the terminal A into the global IP address “20.1.1.10” for use on the Internet, and also converts the global IP address “20.1.1.10” which is set as the destination address in packets transmitted from the Internet into the private IP address “10.1.1.10”, and sends those packets with the private IP address “10.1.1.10” to the terminal A. In the example shown in FIG. 25, therefore, the global IP address “20.1.1.10” and the private IP address “10.1.1.10” are associated with each other. The method of converting IP addresses described above with reference to FIG. 24 may be regarded as a method using the NAT function.

The process of assigning a global IP address to make an Internet connection is called terminal dial-up access. Since only a terminal attempting a connection uses a global IP address according to this process, one global IP address can be shared by the terminals 321 on the LAN 320. However, because the number of global IP addresses that can be used simultaneously by one LAN 320 is predetermined by a contract with JPNIC or an acting agent thereof (an Internet service provider or the like), more terminals on the LAN 320 than those available global IP addresses cannot simultaneously connect to the Internet. In addition, inasmuch as global IP addresses are shared by the terminals 221 on the LAN 320, it is impossible to set, from the Internet, a destination address to a global IP address, e.g., “20.1.1.10” to specify a certain terminal on the LAN 320.

IP masquerade (multi-NAT): IP masquerade (also known as multi-NAT) will be described below. The IP masquerade is similar to the NAT, but differs therefrom in that whereas the NAT converts private IP addresses and global IP addresses, i.e., converts only IP addresses, the IP masquerade performs an address conversion using a port number. As well known in the art, an IP address is positioned in the third layer of the OSI reference model, and destination and source addresses are set in an IP header according to RFC791. A port is assigned to the application compatibility in the fifth layer, which is the highest layer, of the OSI reference model, and a port number is set by the TCP protocol positioned in the fourth layer which is above the IP layer (third layer). Therefore, a port number is not set in an IP header. Port numbers are locally assigned by respective hosts (terminals). Port numbers which are used for application services which cannot initially be processed unless the port numbers are known are fixedly determined as certain port numbers.

FIGS. 26 and 27 of the accompanying drawings are illustrative of the IP masquerade. FIG. 26 shows a network configuration and a model in which IP addresses are used, and FIG. 27 shows, by way of example, an association between private IP addresses and global IP addresses. In the example shown in FIG. 26, a plurality of terminals 421 (also referred to as a terminal A, etc. if a certain individual terminal is mentioned) connected to a private network (hereinafter referred to as a LAN) 420 are assigned respective private IP addresses as shown. FIG. 26 also shows port numbers used in part of applications that are used by the respective terminals 421. Since a port number is assigned to the application compatibility, a plurality of port numbers are normally set in one terminal. In FIG. 26, however, a port number “23” that is fixedly assigned to Telnet which is a type of application is used in all terminals 421, and a port number “21” that is fixedly assigned to FTP (File Transfer Protocol) is used in a terminal E.

According to the IP masquerade, one global IP address (or a given number of global IP addresses) is shared by the terminals 421, and port numbers capable of identifying the terminals are set in combination with the global IP address. For example, all the terminals A through E are assigned a global IP address “20.1.1.10” for making an Internet connection, and combinations of private IP addresses of the terminals 421 and port numbers (corresponding to types of applications) are assigned respective individual port numbers. FIG. 27 shows an association between private IP addresses and global IP addresses including port numbers. In the example shown in FIG. 27, if Telnet is used as an application, then a port number “100” for use on the Internet is assigned to the terminal A, a port number “101” to the terminal B, a port number “102” to the terminal C, a port number “103” to the terminal D, and a port number “104” to the terminal E. If FTP is also used as an application in the terminal E, then a port number “104” is assigned to Telnet (port number “23” on the terminal) and a port number “105” is assigned to FTP (port number “21” on the terminal).

According to the conventional NAT and IP masquerade, as described above, only one-way communications from terminals having private addresses to terminals having global addresses are achieved, but it has been not possible to gain access from terminals having global addresses to terminals having private addresses and also to perform communications between two networks having private addresses. To carry out such access and communications, it is necessary to acquire new global addresses and assign them to terminals having private addresses, thus requiring procedural actions and expenses.

The NAT and the IP masquerade are also problematic in that they can provide only one-way communication services due to the following technical limitations:

1. Since private address networks use respective overlapping address spaces, there is no way of unifying terminals on those private address networks.

2. The present name resolution process based on the DNS architecture provides no means for acquiring the IP address of a terminal on a private address network from a global address network.

3. There is no way for a router of a global address network to handle the route information of a private address. Thus, a TCP connection cannot be set up as there is no IP route from a private address network to a global address network.

### SUMMARY OF THE INVENTION

It is therefore an object of the present invention to provide a communication apparatus and a network system which can achieve communications to a terminal having a private address.

To achieve the above object, there is provided in accordance with the present invention a communication apparatus belonging to a first network which is made up of communication apparatus having addresses of a first type, respectively, and having a second network which is made up of terminals governed thereby and having addresses of a second type, respectively. The communication apparatus comprises managing means for managing names given to terminals belonging to a network governed by another communication apparatus in association with a name given to the other communication apparatus, and means responsive to the reception of a name given to a terminal with which to communicate from one of the terminals, for outputting a request for an address resolution to a corresponding communication apparatus determined by the managing means.

To achieve the above object, there is also provided in accordance with the present invention a network system having a fist network which is made up of communication apparatus having addresses of a first type, respectively, and a second network which is made up of terminals governed by a communication apparatus and having addresses of a second type, respectively. The communication apparatus comprises first managing means for managing addresses of terminals governed thereby in association with names given to the terminals, and second managing means for managing the names of the terminals in association with the communication apparatus which manages the addresses of the terminals, the second managing means comprising means, responsive to a communication request from a terminal governed thereby, for determining another communication apparatus to solve an address of a terminal with which to communicate, the first means comprising means for resolving the address in the other communication apparatus.

The above and other objects, features, and advantages of the present invention will become apparent from the following description when taken in conjunction with the accompanying drawings which illustrate a preferred embodiment of the present invention by way of example.

### BRIEF DESCRIPTION OF THE DRAWINGS

FIG. 1 is a schematic perspective view of an embodiment of the present invention;

FIG. 2 is a detailed block diagram of a router;

FIG. 3 is a diagram of signal flows illustrating a name resolution process which is carried out for gaining access from a terminal A on a private network to a terminal B on a private network;

FIG. 4 is a diagram showing a format of information registered in a communication destination private network name resolution server register;

FIG. 5 is a diagram of signal flows illustrating a process of establishing a TCP connection;

FIG. 6 is a diagram of signal flows illustrating a process of establishing a TCP connection;

FIG. 7 is a diagram showing a format of an entry registered in a communication destination terminal•gateway IP address/port holder;

FIG. 8 is a diagram of signal flows illustrating a process of transferring packets using a TCP connection;

FIG. 9 is a diagram of signal flows illustrating a process of changing two-way communications to one-way communications at the time of finishing a TCP connection;

FIG. 10 is a diagram of signal flows illustrating a process of finishing one-way communications at the time of finishing a TCP connection;

FIG. 11 is a diagram of signal flows illustrating a process of restoring a connection between a router A and a router B when the connection is broken;

FIG. 12 is a diagram of signal flows illustrating a process of restoring a connection between a router B and a router C when the connection is broken;

FIG. 13 is a flowchart of a processing sequence in a router A at the time a name resolution process is carried out;

FIGS. 14 and 15 are a flowchart of a process of establishing a TCP connection;

FIG. 16 is a flowchart of a process of transferring packets using a TCP connection which is established by the process shown in FIGS. 14 and 15;

FIGS. 17 and 18 are a flowchart of a process carried out by a router A and a router B at the time a TCP connection is finished;

FIG. 19 is a flowchart of a process of restoring a TCP connection when the TCP connection is broken;

FIG. 20 is a flowchart of a process of restoring a connection between a router B and a router C when the connection is broken;

FIG. 21 is a diagram showing the structures of IP addresses in different classes;

FIG. 22 is a diagram showing ranges of numbers used in IP addresses in different classes;

FIG. 23 is a diagram showing the numerical values of private IP addresses provided according to RFC1597;

FIG. 24 is a block diagram of an internetwork environment illustrated in FIG. 1 of Japanese laid-open patent publication No. 9-233112, with some descriptions added thereto according to the publication;

FIG. 25 is a diagram illustrative of the NAT function;

FIG. 26 is a diagram showing a network configuration and a model in which IP addresses are used in IP masquerade; and

FIG. 27 is a diagram showing, by way of example, an association between private IP addresses and global IP addresses in IP masquerade.

### DESCRIPTION OF THE PREFERRED EMBODIMENT

An embodiment of the present invention will be described below with reference to the drawings. According to the present invention, a communication apparatus refers to a node such as a router, for example, an address of a first type refers to a global address, for example, and an address of a second type refers to a private address, for example.

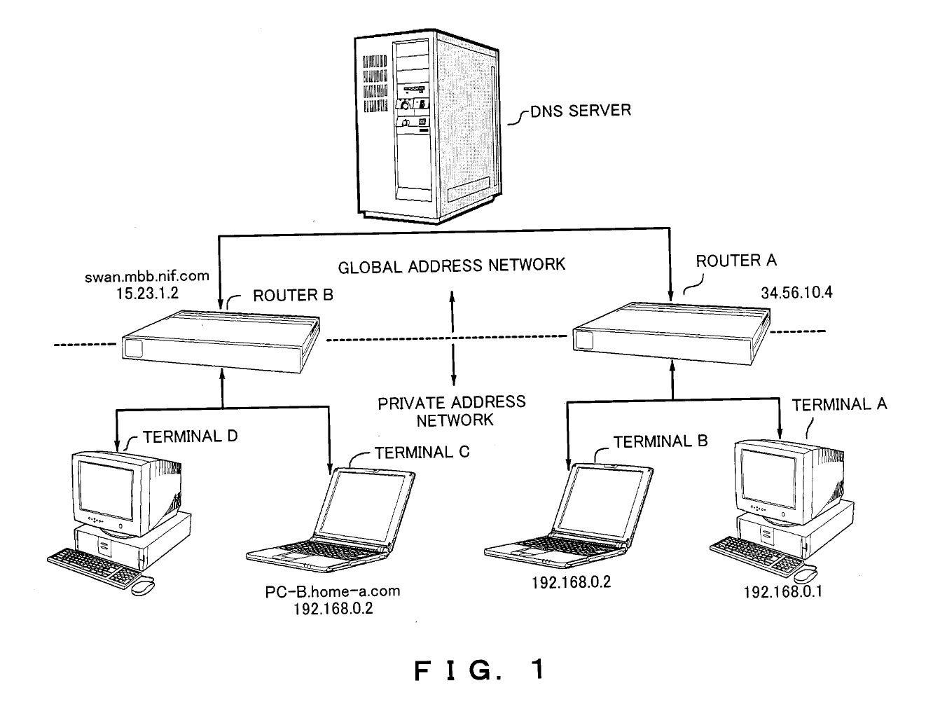

FIG. 1 is a schematic perspective view of an embodiment of the present invention. As shown in FIG. 1, the embodiment of the present invention comprises a plurality of terminals A through D, a pair of routers A, B, and a DNS server.

The terminals A, B are connected to each other by the router A, making up a private address network. The terminal A is assigned a private address 192.168.0.1. The terminal B is assigned a private address 192.168.0.2.

The router A transfers packets between the terminals A, B, and converts addresses if it transfers packets through a global address network. The router A is assigned a global address 34.56.10.4.

The DNS server has a database of data representing an association between the IP addresses of the nodes and the names (host names) thereof. In response to an inquiry from a node, the DNS server searches the database, and sends a result to the node. If an inquiry from a node is about a host of a domain not managed by the DNS server, then the DSN server sends the inquiry to a DNS server (not shown) in a higher level, and sends a result to the node.

The router B transfers packets between the terminals C, D, and converts addresses if it transfers packets through a global address network. The router B is assigned a global address 15.23.1.2 and a host name swan.mbb.nif.com.

The terminals C, D are connected to each other by the router B, making up a private address network. The terminal C is assigned a private address 192.168.0.2 and a host name PC-B.home-a.com. The host name PC-B.home-a.com is an FQDN (Fully Qualified Domain Name).

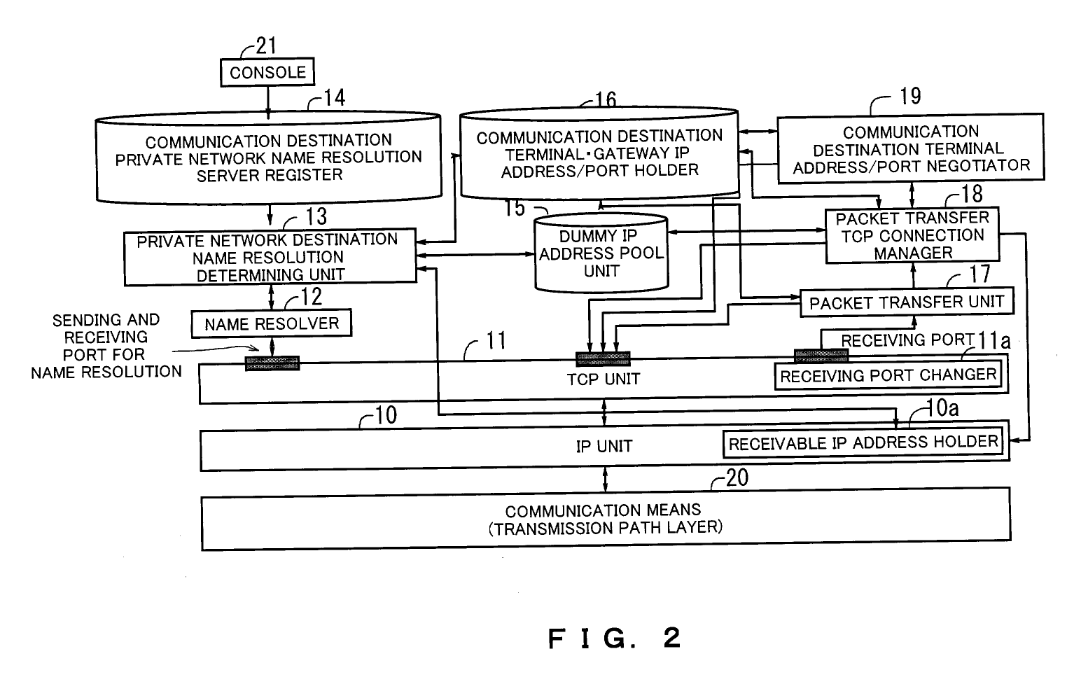

FIG. 2 is a detailed block diagram of each of the routers A, B. As shown in FIG. 2, each of the routers A, B comprises an IP unit 10, a TCP unit 11, a name resolver 12, a private network destination name resolution determining unit 13, a communication destination private network name resolution server register 14, a dummy IP address pool unit 15, a communication destination terminal•gateway IP address/port holder 16, a packet transfer unit 17, a packet transfer TCP connection manager 18, and a communication destination terminal address/port negotiator 19. A communication means 20 and a console 21 are connected as external units to the each of the routers A, B.

The IP unit 10 serves to send and receive TCP packets between two nodes. That is, the IP unit 10 transmits TCP packets between two nodes that are identified by IP addresses. The IP unit 10 has an receivable IP address holder 10a for holding a list of IP addresses that are permitted to be received.

The TCP 11 establishes a connection as a protocol for making communications between two applications. Specifically, the TCP 11 initially establishes a connection between applications, and then carries out two-way communications using the established connection. The TCP unit 11 has a receiving port changer 11a for changing receiving ports.

The name resolver 12 performs a name resolution process if a name resolution request is made based on the DNS.

The private network destination name resolution determining unit 13 checks if there is an entry of an inquiree address in the communication destination private network name resolution server register 14 or not, and performs a name resolution process.

The communication destination private network name resolution server register 14 stores information about a name resolution server for a private network.

The dummy IP address pool unit 15 holds a certain number of dummy IP addresses to be used for communications with a node on a private network.

The communication destination terminal•gateway IP address/port holder 16 registers, as entries, IP addresses and dummy IP addresses of nodes which are required to send and receive data between a receiving terminal and a sending terminal.

The packet transfer unit 17 performs a process required for transferring packets.

The packet transfer TCP connection manager 18 establishes a connection according to an instruction from the packet transfer unit 17.

The communication destination terminal address/port negotiator 19 generates and sends a Notification message and an ACK message.

The communication means 20 is a physical layer including a transmission path. The communication means 20 converts packets supplied from the IP unit 10 into an electric signal, and sends the electric signal. The communication means 20 also converts packets sent from another node into an electric signal, and supplies the electric signal to the IP unit 10.

The console 21 is an interface for registering information in the communication destination private network name resolution server register 14.

Operation of the embodiment of the present invention described above will be described below.

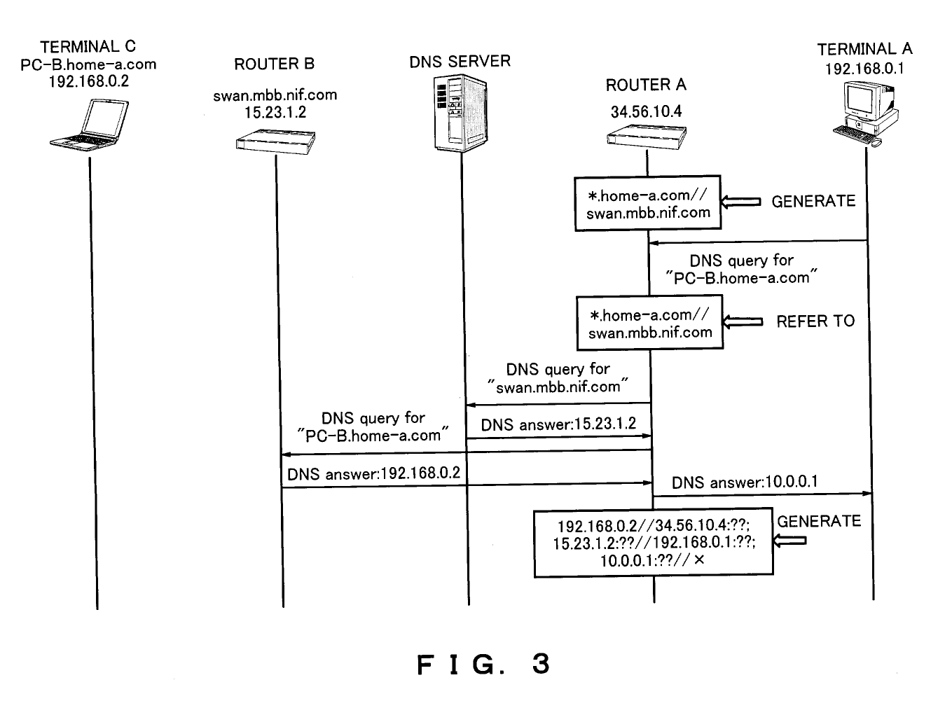

First, a name resolution process for gaining access from the terminal A on the private network to the terminal C on the private network will be described below with reference to FIG. 3.

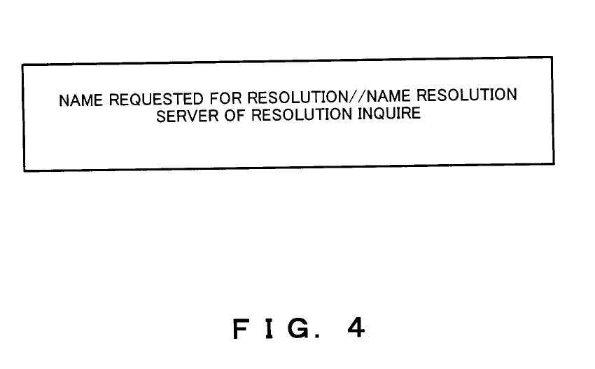

Initially, data shown in FIG. 3 is registered through the console 21 in the communication destination private network name resolution server register 14 of the router A. Specifically, information “_.home-a.com//swan. mbb.nif.com” as shown in FIG. 3 is registered in the communication destination private network name resolution server register 14. As shown in FIG. 4, the registered information comprises a combination of a name requested for resolution and a name resolution server of a resolution inquiree. In the illustrated example, “_.home-a.com” represents a name requested for resolution, and “swan.mbb.nif.com” represents a name resolution server of a resolution inquiree. “_” represents wildcard, meaning an optional character or character string.

Then, the terminal A sends a DNS query to the router A to make an inquiry with respect to PC-B.home-a.com which is the host name of the terminal C (see FIG. 3). The router A receives the DNS query through the communication means 20, the IP unit 10, and the TCP unit 11, and supplies the DNS query through a name resolution sending/receiving port to the name resolver 12.

The name resolver 12 transfers the DNS query to the private network destination name resolution determining unit 13. The private network destination name resolution determining unit 13 searches the entries in the communication destination private network name resolution server register 14, and confirms whether there is an entry corresponding to the DNS query or not. If there is an entry, then the private network destination name resolution determining unit 13 sends information about the entry to the name resolver 12. If there is no entry, then the private network destination name resolution determining unit 13 instructs the name resolver 12 to carry out an ordinary name resolution process.

If instructed to carry out an ordinary name resolution process, the name resolver 12 performs the ordinary name resolution process. Otherwise, the name resolver 12 refers to information about the entry, and identifies a name resolution server of a resolution inquire. In the illustrated example, since the host name of a name resolution server of a resolution inquiree is “swan.mbb.nif.com” and corresponds to the router B, the name resolver 12 sends a DNS query for “swan.mbb.nif.com” to the DNS server in order to acquire an address corresponding to the host name “swan.mbb.nif.com”, as shown in FIG. 3. As a result, the DNS server sends a DNS answer “15.213.1.2” to the server A, which now knows the address of the router B.

Having received the address, the private network destination name resolution determining unit 13 sends a DNS query for “PC-B.home-a.com” to the router B which is a node having the address “15.23.1.2” to inquire the IP address of the terminal C which is a receiving terminal.

The router B assigns unique names to the terminals C, D governed thereby and manages the terminals C, D. In response to the DNS query, the router B searches for an IP address corresponding to the host name, and sends the IP address to the router A. In the illustrated example, the router B acquires the IP address “192.168.0.2” of the terminal C and sends an DNS answer “192.168.0.2” to the router A.

The IP address of the terminal C thus acquired is supplied to the private network destination name resolution determining unit 13. The private network destination name resolution determining unit 13 then acquires one dummy IP address from the dummy IP address pool unit 15, and deletes the acquired dummy IP address from the dummy IP address pool unit 15 in order to prevent the acquired dummy IP address from being used in other communications. In the illustrated example, the private network destination name resolution determining unit 13 acquires a dummy address “10.0.0.1” from the dummy IP address pool unit 15 and deletes the dummy address “10.0.0.1” from the dummy IP address pool unit 15.

Then, the private network destination name resolution determining unit 13 sends the acquired dummy IP address “10.0.0.1” as an answer to the name resolution request to the terminal A. The private network destination name resolution determining unit 13 sends the IP dummy address “10.0.0.1” rather than the private address “192.168.0.2” of the terminal C because private addresses may possibly overlap each other between different private networks. According to the present embodiment, in order prevent private addresses from overlapping each other, a private address governed by the router A, i.e., a private address in class A which is different from a private address in class C, is used as a dummy IP address.

Thus, a private address in class A which is not usually used on the Internet is used as a dummy IP address.

Then, the private network destination name resolution determining unit 13 registers the IP address “10.0.0.1” as an address that can be received in the receivable IP address holder 10a. As a result, packets having the IP address “10.0.0.1” as the destination address are permitted to be received.

Then, the private network destination name resolution determining unit 13 registers the IP addresses of the terminal C as a receiving terminal, the router A, the router B, and the terminal A as a sending terminal as an entry in the communication destination terminal•gateway IP address/port holder 16. Specifically, as shown in FIG. 3, “192.168.0.2//34.56.10.4:??;15.23.1.2:??//192.168.0.1:??;10.0.0.1:??//x” is registered as an entry in the communication destination terminal•gateway IP address/port holder 16. In the entry, port numbers determined by a process described later on are registered in the part “??” following the IP addresses, and “x” represents a communication permission flag. If no communications are permitted, “x” is registered as the communication permission flag, and if communications are permitted, “◯” is registered as the communication permission flag.

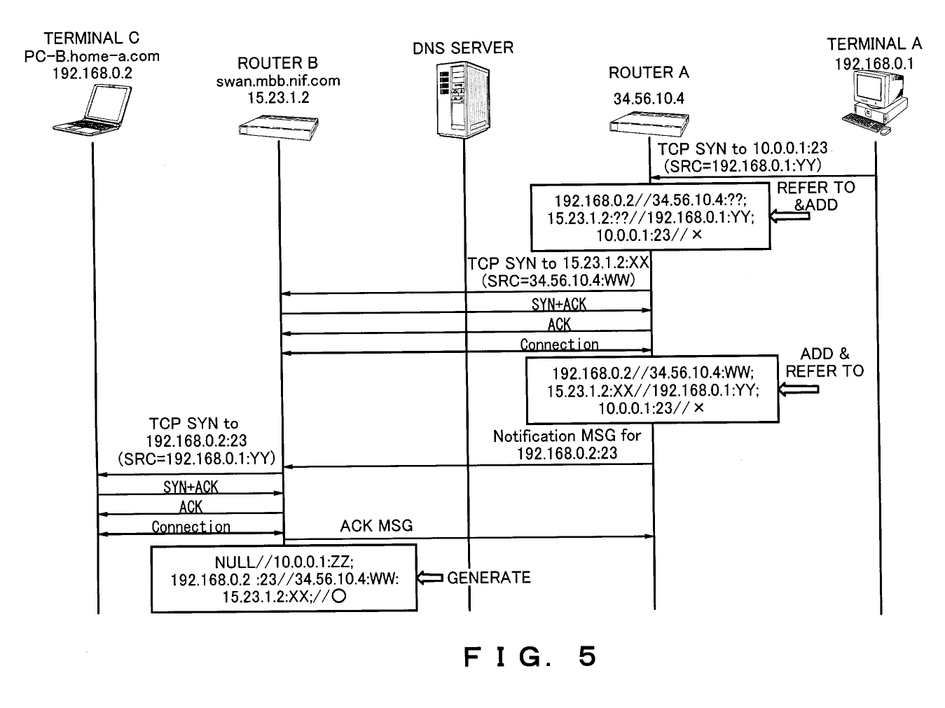

A process of establishing a TCP connection will be described below with reference to FIG. 5.

In order to establish a TCP connection to the port 23 of the terminal C, the terminal A sends a TCP SYN message to the port 23 at the IP address 10.0.0.1 of the router A. As shown in FIG. 5, the source address is 192.168.0.1:YY (SRC=192.168.0.1:YY).

Since the IP unit 10 of the router A holds the IP address 10.0.0.1 in the receivable IP address holder 10a, the router A receives the packet and supplies the received packet through the TCP unit 11 to the packet transfer unit 17.

The packet transfer unit 17 searches the communication destination terminal•gateway IP address/port holder 16 and acquires an entry corresponding to the IP address 10.0.0.1. The entry indicates that the IP address 10.0.0.1 is a routing point through which to route to the address 15.23.1.2, all the port information is undetermined, and the communication permission flag is turned off. Therefore, the packet transfer unit 17 detects that only the name resolution process has been finished for this connection.

The packet transfer unit 17 then instructs the packet transfer TCP connection manager 18 to establish a TCP connection to the address 192.168.0.2 via the address 15.23.1.2.

The packet transfer unit 17 adds the source port address (YY) and the destination port address (23) which are included in the SYN message to the corresponding entry in the communication destination terminal•gateway IP address/port holder 16.

The packet transfer TCP connection manager 18 establishes a TCP connection to the port XX of the address 15.23.1.2 through the TCP unit 11. Specifically, the packet transfer TCP connection manager 18 sends a TCP SYN message to the port 23 of the address 10.0.0.1 (SRC=192.168.0.1:YY) of the router B. As a result, the router B returns “SYN+ACK” to the packet transfer TCP connection manager 18, which then sends “ACK” to the router B. “XX” represents any optional fixed port value assigned to the present process. As a consequence, a TCP connection is established between the router B and the router A.

Then, the packet transfer TCP connection manager 18 registers the connection thus established with the router B in the communication destination terminal•gateway IP address/port holder 16. Specifically, the packet transfer TCP connection manager 18 registers WW and XX, which represent the source port and the destination port of TCP, in the communication destination terminal gateway IP address/port holder 16. As a result, “??” in the entry described above is changed to the corresponding port.

Then, the packet transfer TCP connection manager 18 instructs the communication destination terminal address/port negotiator 19 to send a Notification message (MSG) representing “the port 23 of the address 192.168.0.2” from the TCP connection at the port WW to the port XX of the address 15.23.1.2.

The communication destination terminal address/port negotiator 19 generates a Notification message representing the port 23 of the address 192.168.0.2, and sends the generated Notification message to the router B. As a result, as shown in FIG. 5, the Notification message is sent to the router B.

The TCP unit 11 of the router B supplies the Notification message received through the port XX to the packet transfer unit 17. Since the supplied message is a first packet other than SYN, ACK transmitted from the sending port WW, the packet transfer unit 17 regards the message as a Notification message, and transfers it to the packet transfer TCP connection manager 18.

The packet transfer TCP connection manager 18 then establishes a TCP connection between the address and the port number (the port 23 of the address 192.168.0.2) indicated by the Notification message. Specifically, the packet transfer TCP connection manager 18 sends a TCP SYN message to the port 23 of the address 192.168.0.2 (SRC=192.168.0.1:YY) of the terminal C. As a result, the router C returns “SYN+ACK” to the packet transfer TCP connection manager 18, which then sends “ACK” to the router C. As a consequence, a TCP connection is established between the router C and the router B.

When the TCP connection is established between the router C and the router B, the router B requests the communication destination terminal address/port negotiator 19 to return an ACK message to the router A as a response to the Notification message.

The communication destination terminal address/port negotiator 19 sends, to the router A, an ACK message indicating that the connection to the port 23 of the terminal C (192.168.0.2) is completed.

Then, the communication destination terminal address/port negotiator 19 stores address information and port information about the newly established connection in the communication destination terminal•gateway IP address/port holder 16. Specifically, the communication destination terminal address/port negotiator 19 writes, in the communication destination terminal•gateway IP address/port holder 16, an entry having the destination address and the port (192.168.0.2:23) and the source address and the port (10.0.0.1:ZZ) of the newly established connection, the source address and the port (34.56.10.4:WW) and the destination address and the port (15.23.1.2:XX) of the TCP connection through which the Notification message has been sent, and an on communication permission flag.

Then, the communication destination terminal address/port negotiator 19 notifies the packet transfer TCP connection manager 18 that the connection to the port 23 of the address 192.168.0.2 has been established via the TCP connection from the port XX of the address 15.23.1.2 to the port WW of the address 34.56.10.4.

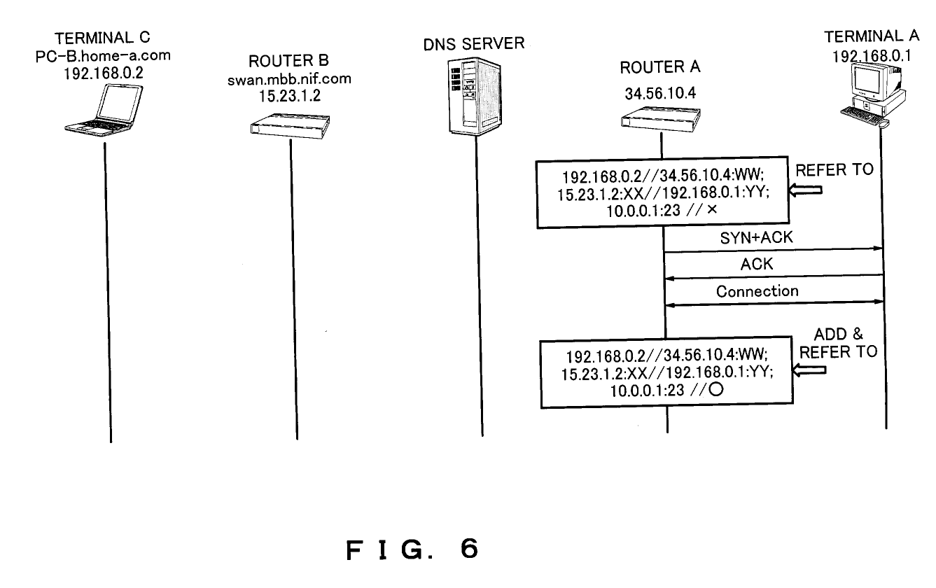

The packet transfer TCP connection manager 18 searches the communication destination terminal•gateway IP address/port holder 16 using “34.536.10.4:WW;15.23.1.2:XX” as a key, and acquires a corresponding entry. By referring to the information contained in the acquired entry (see FIG. 6), the packet transfer TCP connection manager 18 detects that the connection to the terminal A based on the ACK message sent thereto is between the address 192.168.0.1:YY and the address 10.0.0.1:23.

The packet transfer TCP connection manager 18 establishes a connection between the address 192.168.0.1:YY and the address 10.0.0.1:23 through the TCP unit 11. Specifically, the packet transfer TCP connection manager 18 sends “SYN+ACK” to the terminal A, and receives “ACK” returned from the terminal A in response to “SYN+ACK”. As a result, a connection is established between the terminal A and the router A (see FIG. 6).

Finally, the packet transfer TCP connection manager 18 changes the communication permission flag in the entry “192.168.0.2//34.56.10.4:WW;15.23.1.2:XX//192.168.0.1:YY;10.0.0.1:23//x” registered in the communication destination terminal•gateway IP address/port holder 16 from an off state (x) to an on state (◯) (see FIG. 6).

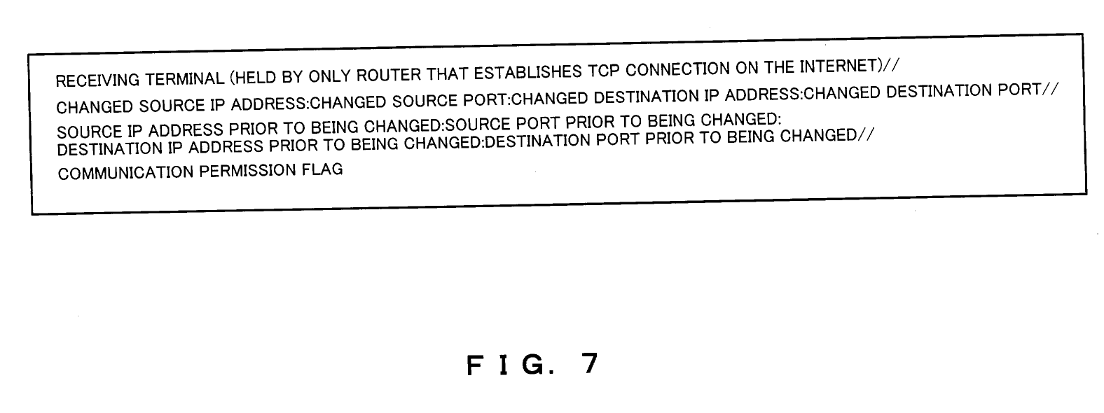

The entry registered in the communication destination terminal•gateway IP address/port holder 16 comprises, as shown in FIG. 7, a receiving terminal, a changed source IP address, a changed source port, a changed destination IP address, a changed destination port, a source IP address prior to being changed, a source port prior to being changed, a destination IP address prior to being changed, a destination port prior to being changed, and a communication permission flag.

The “receiving terminal” signifies the IP address (192.168.0.2) of the terminal C, and represents information which is held by only a router that establishes a TCP connection on the Internet.

The “changed source IP address” and the “changed source port” represent the source IP address and the source port number after the address is changed. In the illustrated example, they correspond to 34.56.10.4 which is the IP address of the router A and the port number WW.

The “changed destination IP address” and the “changed destination port” represent the destination IP address and the destination port number after the address is changed. In the illustrated example, they correspond to 15.23.1.2 which is the IP address of the router B and the port number XX.

The “source IP address prior to being changed” and the “source port prior to being changed” represent the source IP address and the source port number before the address is changed. In the illustrated example, they correspond to 192.168.0.1 which is the IP address of the router A and the port number YY.

The “destination IP address prior to being changed” and the “destination port prior to being changed” represent the destination IP address and the destination port number before the address is changed. In the illustrated example, they correspond to 10.0.0.1 which is the dummy IP address and the port number 23.

The “communication permission flag” represents information indicative of whether communications are permitted for the entry. If communications are permitted for the entry, then the communication permission flag is set to “◯”. If communications are not permitted for the entry, then the communication permission flag is set to “x”. If one-way communications are permitted for the entry, then the communication permission flag is set to “Δ”.

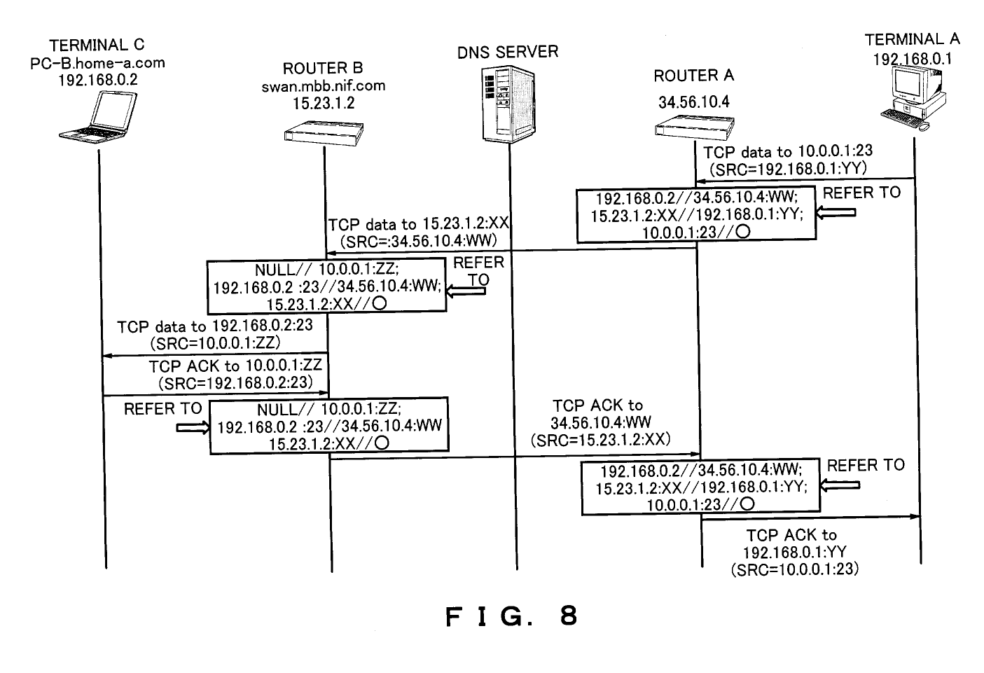

A process of transferring packets using the TCP connection that has been established by the above process will be described below with reference to FIG. 8.

The terminal A sends a packet having a header indicative of a destination of 10.0.0.1:23 and a source of 192.168.0.1:YY (TCP data to 10.0.0.1:23 (SRC=192.168.0.1:YY)) to the router A. The router A receives the packet sent from the terminal A.

Since the IP unit 10 of the router A holds the address 10.0.0.1:23 in the receivable IP address holder 10a, the IP unit 10 receives the packet and transfers the received packet to the packet transfer unit 17 through the TCP unit 11.

The packet transfer unit 17 searches the communication destination terminal•gateway IP address/port holder 16, and acquires a corresponding entry therefrom. In the illustrated embodiment, the packet transfer unit 17 acquires an entry “192.168.0.2//34.56.10.4:WW;15.23.1.2:XX//192.168.0.1:YY;10.0.0.1:23//◯” shown in FIG. 8. The packet transfer unit 17 refers to the information contained in the entry, converts 10.0.0.1:23, which represents the destination IP address and the port information contained in the header of the packet, into 15.23.1.2:XX, and also converts 192.168.0.1:YY, which represents the source IP address and the port information, into 34.56.10.4:WW. The packet transfer unit 17 does not convert the datagram in the packet.

The packet transfer unit 17 sends the packet whose header has been converted to the router B through the TCP unit 11.

The router B receives the packet transmitted from the router A, reads the packet through the port XX, and supplies the packet to the packet transfer unit 17 thereof.

The packet transfer unit 17 searches the communication destination terminal•gateway IP address/port holder 16, and acquires an entry corresponding to the received packet therefrom, i.e., an entry “NULL//10.0.0.1:ZZ;192.168.0.2:23//34.56.10.4:WW;15.23.1.2:XX//◯”. The packet transfer unit 17 refers to the information contained in the acquired entry, converts 15.23.1.2:XX, which represents the destination IP address and the port information contained in the header of the packet, into 192.168.0.2:23, and also converts 192.168.0.1:YY, which represents the source IP address and the port information, into 10.0.0.1:ZZ. The packet transfer unit 17 does not convert the datagram in the packet, and sends the packet whose header has been converted to the terminal C through the TCP unit 11.

As a result, the packet sent from the terminal A reaches the terminal C belonging to the private address network.

Then, the terminal C generates a packet as a response to the received packet, sets the destination IP address and the port thereof to 10.0.0.1:ZZ and the source IP address and the port thereof to 192.168.0.2:23, and sends the packet. The destination IP address 10.0.0.1:ZZ is used to prevent the packet from being transmitted in error to another node on the private address network to which the terminal C belongs.

The packet sent from the terminal C is received by the router B, and supplied to the IP unit 10 thereof. Since the IP unit 10 of the router C holds the address 10.0.0.1:ZZ in the receivable IP address holder 10a, the IP unit 10 receives the packet and transfers the received packet to the packet transfer unit 17 through the TCP unit 11.

The packet transfer unit 17 searches the communication destination terminal•gateway IP address/port holder 16, and acquires a corresponding entry therefrom. In the illustrated embodiment, the packet transfer unit 17 acquires an entry “NULL//10.0.0.1:ZZ/192.168.0.2:23//34.56.10.4:WW;15.23.1.2:XX//◯” shown in FIG. 8. The packet transfer unit 17 refers to the information contained in the entry, converts 10.0.0.1:ZZ, which represents the destination IP address and the port information contained in the header of the packet, into 34.56.10.4:WW, and also converts 192.168.0.2:23, which represents the source IP address and the port information, into 15.23.1.2:XX. The packet transfer unit 17 does not convert the datagram in the packet.

The packet transfer unit 17 sends the packet whose header has been converted to the router A through the TCP unit 11.

The router A receives the packet transmitted from the router B, reads the packet through the port WW, and supplies the packet to the packet transfer unit 17 thereof.

The packet transfer unit 17 searches the communication destination terminal•gateway IP address/port holder 16, and acquires an entry corresponding to the received packet therefrom, i.e., an entry “192.168.0.2//34.56.10.4:WW;15.23.1.2:XX//192.168.0.1:YY;10.0.0.1:23//◯”. The packet transfer unit 17 refers to the information contained in the acquired entry, converts 34.56.10.4:WW, which represents the destination IP address and the port information contained in the header of the packet, into 192.168.0.1:YY, and also converts 15.23.1.2:XX, which represents the source IP address and the port information, into 10.0.0.1:23. The packet transfer unit 17 does not convert the datagram in the packet, and sends the packet whose header has been converted to the terminal A through the TCP unit 11.

As a result, the packet sent from the terminal C reaches the terminal A belonging to the private address network.

According to the above process, it is possible to send and receive packets between the terminal A and the terminal C which belong to the respective private address networks.

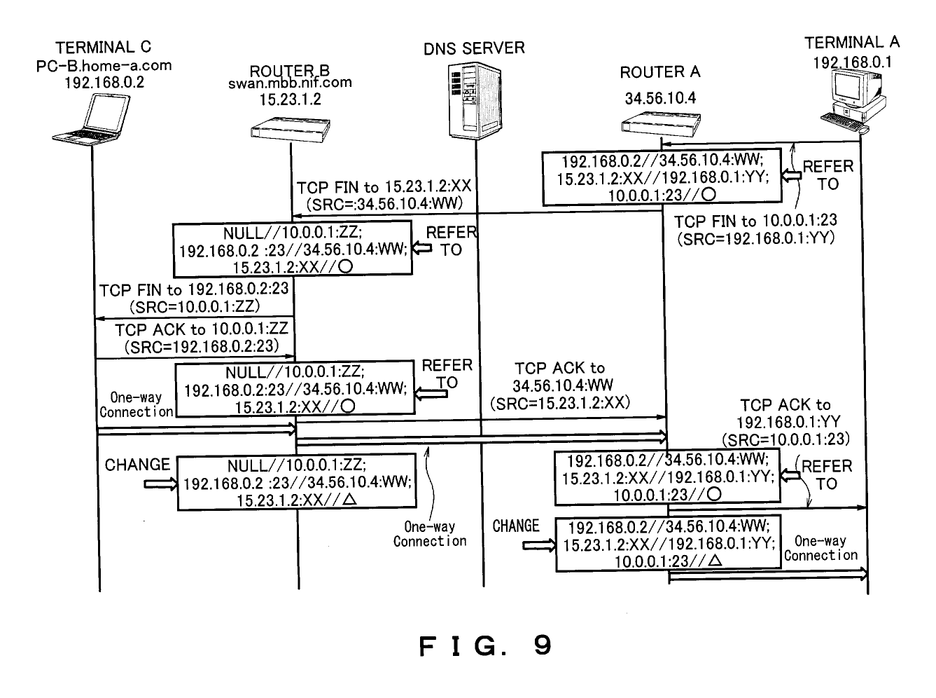

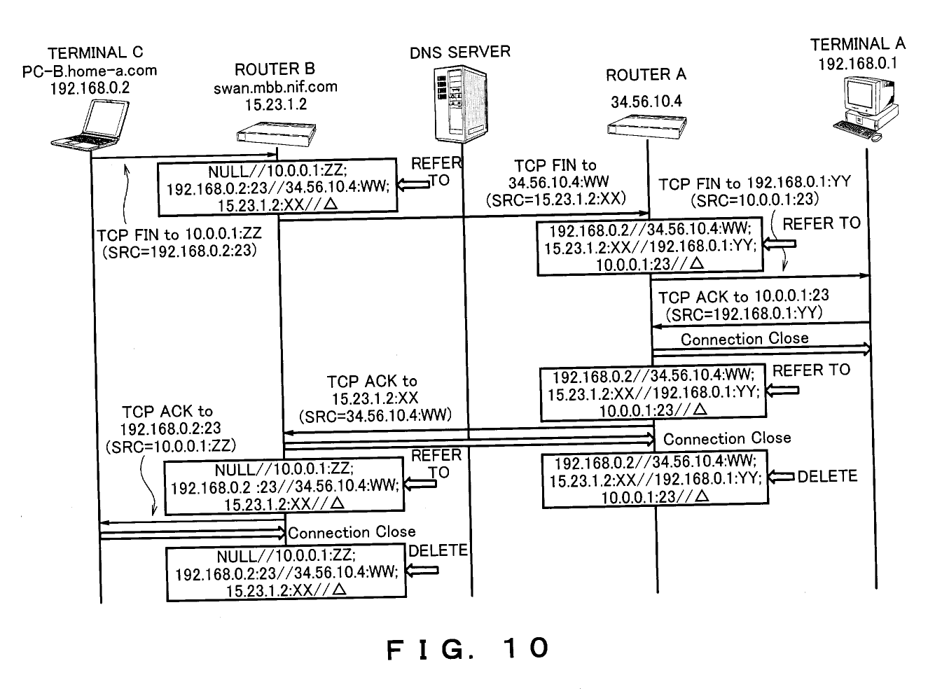

Processes carried out for finishing a TCP connection will be described below with reference to FIGS. 9 and 10.

First, a process of changing two-way communications to one-way communications will be described below with reference to FIG. 9.

When the terminal A sends a TCP FIN message for finishing a TCP connection to the port 23 of the address 10.0.0.1 (SRC=192.168.0.1:YY), the router A receives the TCP FIN message via the port 23.

Since the destination address 10.0.0.1 contained in the header of the received packet is stored in the receivable IP address holder 10a, the IP unit 10 of the router A judges the received packet as being a receivable packet, and supplies the packet to the packet transfer unit 17 through the TCP unit 11.

The packet transfer unit 17 notifies the packet transfer TCP connection manager 18 that a FIN message has come from the TCP connection whose destination IP address and port information is represented by 10.0.0.1:23 and whose source IP address and port information is represented by 192.168.0.1:YY.

The packet transfer unit 17 searches the communication destination terminal•gateway IP address/port holder 16, converts 10.0.0.1:23, which represents the destination IP address and the port information, into 15.23.1.2:XX, and also converts 192.168.0.1:YY, which represents the source IP address and the port information, into 34.56.10.4:WW. The packet transfer unit 17 does not convert the datagram in the packet, and sends the packet whose header has been converted to the router B through the TCP unit 11.

When the packet has been sent, the packet transfer TCP connection manager 18 of the router A searches the communication destination terminal•gateway IP address/port holder 16, and waits for an ACK message to be returned in response to the FIN message from the connection whose destination IP address and port information is represented by 34.56.10.4:WW and whose source IP address and port information is represented by 15.23.1.2:XX.

The router B receives the packet sent from the router A via the port XX, and supplies the received packet to the packet transfer unit 17.

The packet transfer unit 17 notifies the packet transfer TCP connection manager 18 that the FIN message has arrived from the TCP connection whose destination IP address and port information is represented by 15.23.1.2:XX and whose source IP address and port information is represented by 34.56.10.4:WW.

The packet transfer unit 17 searches the communication destination terminal•gateway IP address/port holder 16, converts 15.23.1.2:XX, which represents the destination IP address and the port information, into 192.168.0.2:23, and also converts 34.56.10.4.WW, which represents the source IP address and the port information, into 10.0.0.1:ZZ. The packet transfer unit 17 does not convert the datagram in the packet, and sends the packet whose header has been converted to the terminal C through the TCP unit 11.

The packet transfer TCP connection manager 18 searches the communication destination terminal•gateway IP address/port holder 16, and waits for an ACK message to be returned in response to the FIN message from the connection whose destination IP address and port information is represented by 10.0.0.1:ZZ and whose source IP address and port information is represented by 192.168.0.2:23.

Then, the terminal C receives the FIN message sent from the router B, and sends a TCP ACK message in response thereto to the port ZZ of the address 10.0.0.1 (SRC=192.168.0.2:23).

The router B receives the packet sent from the terminal C via the port ZZ, and supplies the received packet to the packet transfer unit 17.

The packet transfer unit 17 notifies the packet transfer TCP connection manager 18 that an ACK message has arrived from the TCP connection whose destination IP address and port information is represented by 10.0.0.1:ZZ and whose source IP address and port information is represented by 192.168.0.2:23.

The packet transfer unit 17 searches the communication destination terminal•gateway IP address/port holder 16, converts 10.0.0.1:ZZ, which represents the destination IP address and the port information, into 34.56.10.4:WW, and also converts 192.168.0.2:23, which represents the source IP address and the port information, into 15.23.1.2:WW. The packet transfer unit 17 does not convert the datagram in the packet, and sends the packet whose header has been converted to the router A through the TCP unit 11.

The packet transfer TCP connection manager 18 changes the communication permission flag in the corresponding entry “NULL//10.0.0.1:ZZ/192.168.0.2:23//34.56.10.4:WW;15.23.1.2:XX//◯” stored in the communication destination terminal•gateway IP address/port holder 16, from “◯” indicative of communication permission to “Δ” indicative of one-way communications.

As a result, the connection between the terminal C and the router B becomes a one-way connection.

The router A receives the packet sent from the router B via the port WW, and supplies the received packet to the packet transfer unit 17.

The packet transfer unit 17 notifies the packet transfer TCP connection manager 18 that an ACK message has arrived from the TCP connection whose destination IP address and port information is represented by 34.56.10.4:WW and whose source IP address and port information is represented by 15.23.1.2:XX.

The packet transfer unit 17 searches the communication destination terminal•gateway IP address/port holder 16, converts 34.56.10.4:WW, which represents the destination IP address and the port information, into 192.168.0.1:YY, and also converts 15.23.1.2:XX, which represents the source IP address and the port information, into 10.0.0.1:23. The packet transfer unit 17 does not convert the datagram in the packet, and sends the packet whose header has been converted to the terminal A through the TCP unit 11.

The packet transfer TCP connection manager 18 changes the communication permission flag in the corresponding entry “192.168.0.2//34.56.10.4:WW;15.23.1.2:XX//192.168.0.1:YY;10.0.0.1:23//◯” stored in the communication destination terminal•gateway IP address/port holder 16, from “◯” indicative of communication permission to “Δ” indicative of one-way communications.

As a result, the connection between the router B and the router A and between the router A and the terminal A becomes a one-way connection.

A process finishing a TCP connection from one-way communications will be described below with reference to FIG. 10.

When the terminal C sends a TCP FIN message for finishing a TCP connection to the port ZZ of the address 10.0.0.1 (SRC=192.168.0.2:23), the router B receives the TCP FIN message via the port ZZ.

Since the destination address 10.0.0.1 contained in the header of the received packet is stored in the receivable IP address holder 10a, the IP unit 10 of the router B judges the received packet as being a receivable packet, and supplies the packet to the packet transfer unit 17 through the TCP unit 11.

The packet transfer unit 17 notifies the packet transfer TCP connection manager 18 that a FIN message has arrived from the TCP connection whose destination IP address and port information is represented by 10.0.0.1:ZZ and whose source IP address and port information is represented by 192.168.0.2:23.

The packet transfer unit 17 searches the communication destination terminal•gateway IP address/port holder 16, converts 10.0.0.1:ZZ, which represents the destination IP address and the port information, into 34.56.10.4:WW, and also converts 192.168.0.2:23, which represents the source IP address and the port information, into 15.23.1.2:XX. The packet transfer unit 17 does not convert the datagram in the packet, and sends the packet whose header has been converted to the router A through the TCP unit 11.

When the packet has been sent, the packet transfer TCP connection manager 18 of the router B searches the communication destination terminal•gateway IP address/port holder 16, and waits for an ACK message to be returned in response to the FIN message from the connection whose destination IP address and port information is represented by 15.23.1.2:XX and whose source IP address and port information is represented by 34.5.10.4:WW.

The router A receives the packet sent from the router B via the port WW, and supplies the received packet to the packet transfer unit 17.

The packet transfer unit 17 of the router A notifies the packet transfer TCP connection manager 18 that a FIN message has arrived from the TCP connection whose destination IP address and port information is represented by 34.56.10.4:WW and whose source IP address and port information is represented by 15.23.1.2:XX.

The packet transfer unit 17 searches the communication destination terminal•gateway IP address/port holder 16, converts 34.56.10.4:WW, which represents the destination IP address and the port information, into 192.168.0.1:YY, and also converts 15.23.1.2:XX, which represents the source IP address and the port information, into 10.0.0.1:23. The packet transfer unit 17 does not convert the datagram in the packet, and sends the packet whose header has been converted to the terminal A through the TCP unit 11.

The packet transfer TCP connection manager 18 searches the communication destination terminal•gateway IP address/port holder 16, and waits for an ACK message to be returned in response to the FIN message from the connection whose destination IP address and port information is represented by 10.0.0.1:23 and whose source IP address and port information is represented by 192.168.0.1:YY.

When the terminal A sends a TCP ACK message in response to the FIN message to the port 23 of the address 10.0.0.1 (SRC=192.168.0.1:YY), the router A receives the TCP ACK message and supplies it to the packet transfer unit 17.

The packet transfer unit 17 notifies the packet transfer TCP connection manager 18 that an ACK message has arrived from the TCP connection whose destination IP address and port information is represented by 10.0.0.1:23 and whose source IP address and port information is represented by 192.168.0.1:YY.

The packet transfer unit 17 searches the communication destination terminal•gateway IP address/port holder 16, converts 10.0.0.1:23, which represents the destination IP address and the port information, into 15.23.1.2:XX, and also converts 192.168.0.1:YY, which represents the source IP address and the port information, into 34.56.10.4:WW. The packet transfer unit 17 does not convert the datagram in the packet, and sends the packet whose header has been converted to the router B through the TCP unit 11.

The packet transfer TCP connection manager 18 then deletes a corresponding entry “192.168.0.2//34.56.10.4:WW;15.23.1.2:XX//192.168.0.1:YY;10.0.0.1:23//Δ” stored in the communication destination terminal•gateway IP address/port holder 16.

As a result, the connection between the terminal A and the router A changes from a one-way connection to a closed connection. The packet transfer TCP connection manager 18 of the router A also notifies the receivable IP address holder 10a of stopping receiving the dummy address, i.e., 10.0.0.1, described as the destination IP address prior to being changed in the entry, and returns the dummy address to the dummy IP address pool unit 15.

The router B receives the packet sent from the router A via the port XX, and supplies the received packet to the packet transfer unit 17.

The packet transfer unit 17 notifies the packet transfer TCP connection manager 18 that an ACK message has arrived from the TCP connection whose destination IP address and port information is represented by 15.23.1.2:XX and whose source IP address and port information is represented by 34.56.10.4:WW.

The packet transfer unit 17 searches the communication destination terminal•gateway IP address/port holder 16, converts 15.23.1.2:XX, which represents the destination IP address and the port information, into 192.168.0.2:23, and also converts 34.56.10.4.WW, which represents the source IP address and the port information, into 10.0.0.1:ZZ. The packet transfer unit 17 does not convert the datagram in the packet, and sends the packet whose header has been converted to the terminal C through the TCP unit 11.

The packet transfer TCP connection manager 18 then deletes a corresponding entry “192.168.0.2//34.56.10.4:WW;15.23.1.2:XX//192.168.0.1:YY;10.0.0.1:23//Δ” stored in the communication destination terminal•gateway IP address/port holder 16.

As a result, the connection between the terminal C and the router B and between the router B and the router A changes from a one-way connection to a closed connection. The packet transfer TCP connection manager 18 of the router A also notifies the receivable IP address holder 10a of stopping receiving the dummy address, i.e., 10.0.0.1, described as the changed destination IP address in the entry, and returns the dummy address to the dummy IP address pool unit 15.

According to the above process, it is possible to finish a connection which has been established.

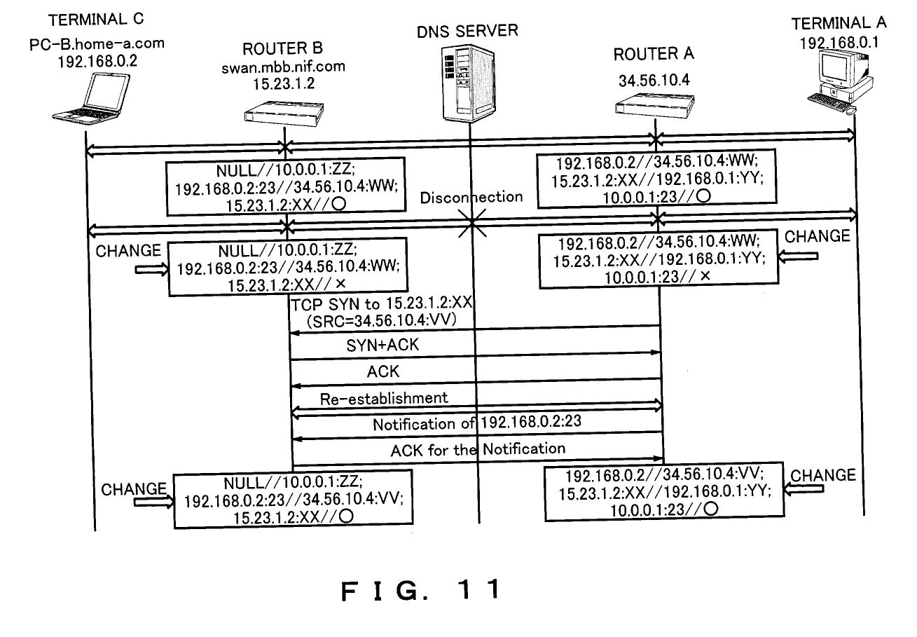

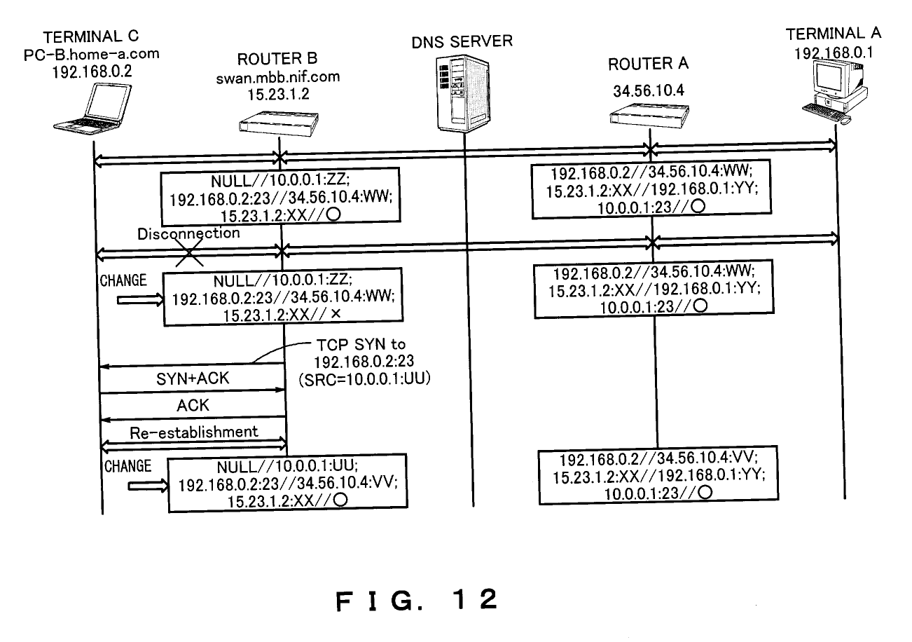

Processes for restoring a connection between the router A and the router B when the connection is broken will be described below with reference to FIGS. 11 and 12.

FIG. 11 shows a process of restoring a connection between the router A and the router B when the connection is broken.

As shown in FIG. 11, when a connection between the router A and the router B is broken, the TCP unit 11 of the router A and the TCP unit 11 of the router B detect that the connection is broken.

The TCP unit 11 of the router A which has detected the break of the connection notifies the packet transfer TCP connection manager 18 of the IP addresses and port numbers of the both ends (the router A and the router B) of the broken connection.

The packet transfer TCP connection manager 18 of the router A searches the communication destination terminal•gateway IP address/port holder 16 using the data received from the TCP unit 11 as a key, and turns off the communication permission flag in an entry from the result of the search. Since the “receiving terminal” field is not NULL, the packet transfer TCP connection manager 18 recognizes that the router A thereof is a node which has established the TCP on its own, and instructs the TCP unit 11 to establish a TCP connection between itself and the port XX of the router B.

As a result, the TCP 11 sends a TCP SYN message to the port XX of the address 15.23.1.2 (SRC=34.56.10.4:VV) in order to establish a connection to the router B.

At this time, the packet transfer TCP connection manager 18 of the router B searches the communication destination terminal•gateway IP address/port holder 16 using the data received from the TCP unit 11 as a key, and turns off the communication permission flag in an entry from the result of the search. Since the “receiving terminal” field is not NULL, the packet transfer TCP connection manager 18 recognizes that the router B thereof is not a node which has established the TCP on its own, and waits for the re-establishment of a connection from the router A.

When a SYN message sent from the router A arrives at the router B, the router B sends a “SYN+ACK” message to the router A. The router A returns an ACK message, whereupon a connection between the router A and the router B is re-established.

When the connection between the router A and the router B is re-established, the router A sends a Notification message to the router B in the same manner as described above.

Having received the Notification message, the router B sends an ACK message in response thereto, rewrites the source port number prior to being changed in the corresponding entry in the communication destination terminal•gateway IP address/port holder 16 into a new port number (VV), and turns on the communication permission flag.

The router A receives the ACK message, rewrites the source port number prior to being changed in the corresponding entry in the communication destination terminal•gateway IP address/port holder 16 into a new port number (VV), and turns on the communication permission flag.

According to the above process, it is possible to re-establish a connection between the router A and the router B when the connection is broken and to continue the communications.

A process of restoring a connection between the router B and the terminal C when the connection is broken will be described below with reference to FIG. 12.

If a connection between the router B and the terminal C is broken for some reason, the break of the connection is detected by the TCP unit 11 of the router B.

The TCP unit 11 of the router B notifies the packet transfer TCP connection manager 18 of the IP addresses and port numbers of the both ends (the router B and the terminal C) of the broken connection.

The packet transfer TCP connection manager 18 of the router B searches the communication destination terminal•gateway IP address/port holder 16 using the data received from the TCP unit 11 as a key, and turns off the “communication permission flag” in an entry from the result of the search. The packet transfer TCP connection manager 18 instructs the TCP unit 11 to establish a TCP connection between itself and the port 23 of the terminal C.

As a result, the router B sends a TCP SYN message to the port 23 of the address 192.168.0.2 (SRC=10.0.0.1:UU) of the terminal C.

The terminal C receives the TCP SYN message, and sends a “SYN+ACK” message in response thereto to the router B.

Having received the “SYN+ACK” message from the terminal C, the router B sends an ACK message to the terminal C, changes the changed source port number in the corresponding entry in the communication destination terminal•gateway IP address/port holder 16 to a new port number (UU), and turns on the communication permission flag.

According to the above process, it is possible to restore the connection between the router B and the terminal C which has been broken for some reason to continue the communications. The same restoring process is carried out if a TCP connection between the router A and the terminal A is broken for some reason.

Finally, the processes that are carried out in the above embodiment described above will be described below with reference to flowcharts.

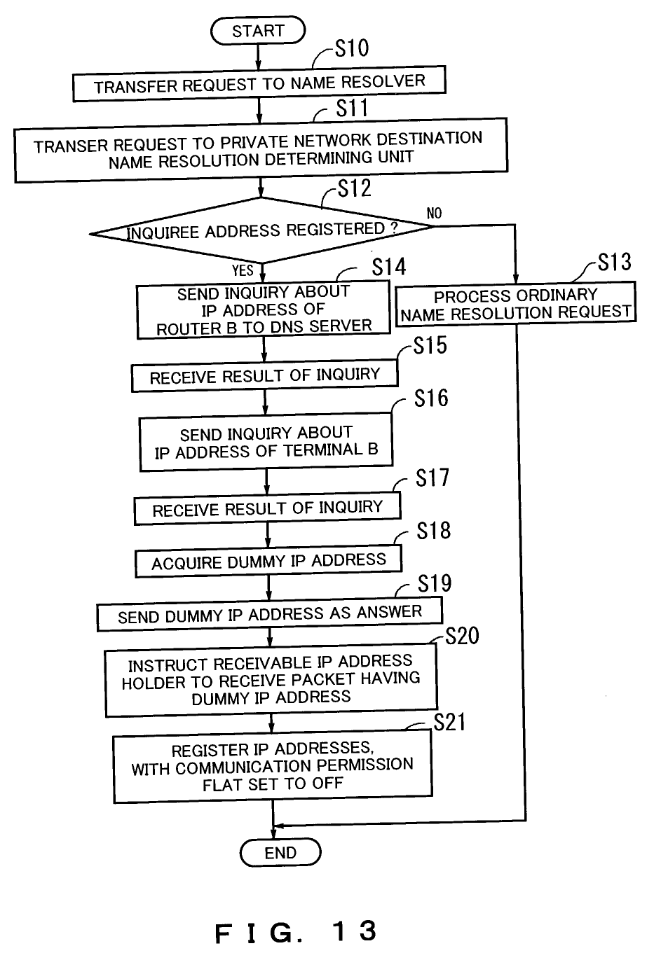

FIG. 13 is a flowchart of a processing sequence in the router A at the time the name resolution process shown in FIG. 2 is carried out. The processing sequence shown in FIG. 13 is executed when a name resolution request has arrived at the router A. It is assumed in the processing sequence that a name resolution request “PC-B.home.com” has arrived at the router A.

STEP S10:

The name resolver 12 receives a name resolution request “PC-B.home.com” sent from the terminal A through the communication means 20, the IP unit 10, and the TCP unit 11.

Step S11:

The name resolver 12 transfers the name resolution request to the private network destination name resolution determining unit 13.

Step S12:

The private network destination name resolution determining unit 13 searches the communication destination private network name resolution server register 14 to determine whether an entry corresponding to the inquiree address is registered or not. If an entry corresponding to the inquiree address is registered, then the processing goes to STEP S14. Otherwise, the processing goes to STEP S13.

Step S13:

The name resolver 12 processes the name resolution request as an ordinary name resolution request.

Step S14:

The private network destination name resolution determining unit 13 instructs the name resolver 12 to send an inquiry about the IP address of the router B (swan.mbb.nif.com) to a certain DNS server on the global network.

Step S15:

The private network destination name resolution determining unit 13 receives a result (15.23.1.2) of the inquiry returned from the DNS server through the communication means 20, the IP unit 10, the TCP unit 11, and the name resolver 12.

Step S16:

The private network destination name resolution determining unit 13 instructs the name resolver 12 to send an inquiry about the IP address of the receiving terminal B (PC-B.home-a.com) to the address 15.23.1.2 (the router B).

Step S17:

The private network destination name resolution determining unit 13 receives a result (192.168.0.2) of the inquiry returned from the router B through the communication means 20, the IP unit 10, the TCP unit 11, and the name resolver 12.

Step S18:

The private network destination name resolution determining unit 13 selects an optional dummy IP address (e.g., 10.0.0.1) from the dummy IP address pool unit 15, and deletes the selected dummy IP address from the dummy IP address pool unit 15.

Step S19:

The private network destination name resolution determining unit 13 sends the dummy IP address (e.g., 10.0.0.1) as an answer of the name resolution request to the terminal A.

Step S20:

The private network destination name resolution determining unit 13 instructs the receivable IP address holder 10a to receive a packet having the dummy IP address as the destination address from the private network.

Step S21:

The private network destination name resolution determining unit 13 registers the IP addresses of the terminal B, the router A, the router B, and the terminal A as an entry in the communication destination terminal•gateway IP address/port holder 16. The communication permission flag is set to an off state.

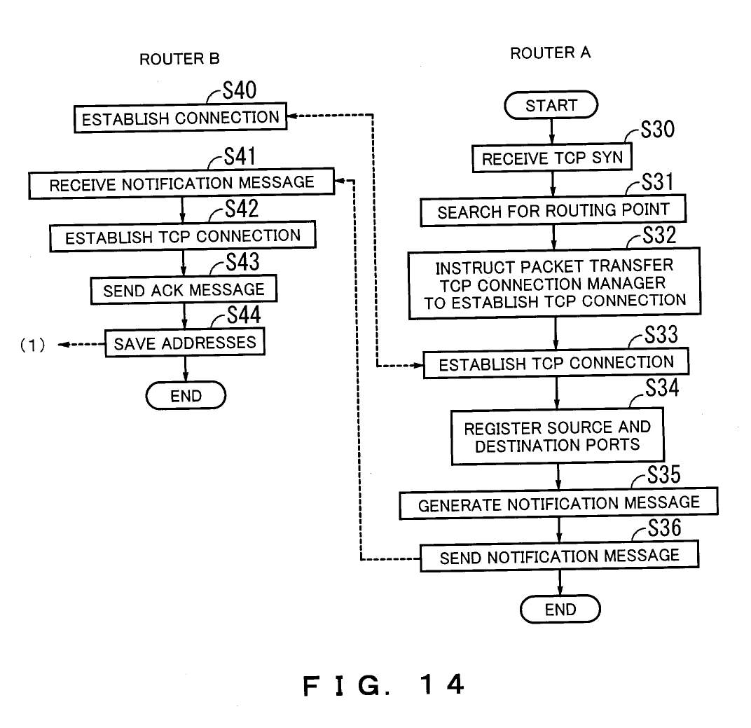

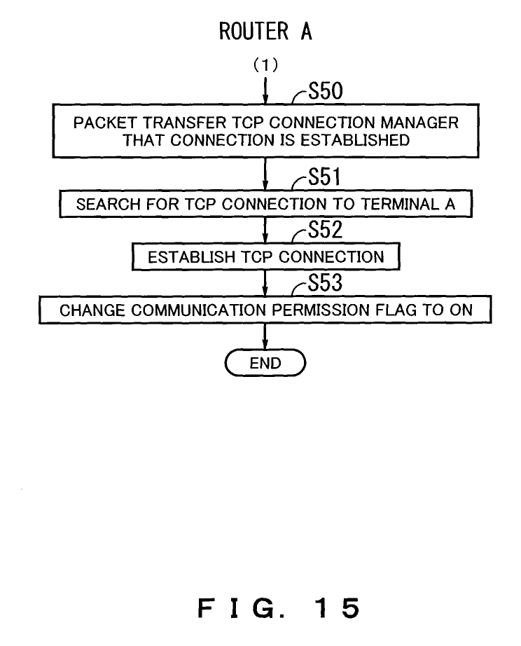

A process of establishing a TCP connection will be described below with reference to FIGS. 14 and 15. First, the process will be described below with reference to FIG. 14. It is assumed in the process that a TCP connection is to be established between the router A and the router B. When a TCP SYN message whose destination IP address is represented by 10.0.0.1 and whose destination port is represented by 23 arrives from the terminal A at the router A, the following steps are carried out:

Step S30:

The IP unit 10 of the router A refers to the receivable IP address holder 10a, receives the packet because the IP address 10.0.0.1 is registered in the receivable IP address holder 10a, and supplies the packet to the packet transfer unit 17 through the TCP unit 11.

Step S31:

The packet transfer unit 17 searches the communication destination terminal•gateway IP address/port holder 16 for a routing point through which to send the packet. Specifically, the packet transfer unit 17 searches the communication destination terminal•gateway IP address/port holder 16 and detects that the IP address 10.0.0.1 is at a routing point through which to route to the IP address 15.23.1.2. Since all the port information is not entered, and the communication permission flag is turned off, the packet transfer unit 17 detects that only the name resolution process has been finished.

Step S32:

The packet transfer unit 17 instructs the packet transfer TCP connection manager 18 to establish a TCP connection between the IP address 15.23.1.2 and the IP address 192.168.0.2.

Step S33:

The packet transfer TCP connection manager 18 establishes a TCP connection between the router A and the port XX of the IP address 15.23.1.2. As a result, a connection is established between the router B and the router A in combination with the processing in STEP S40.

Step S34:

The packet transfer TCP connection manager 18 writes the TCP source and destination ports (WW, XX) with respect to the connection established in STEP S33, in the corresponding entry in the communication destination terminal•gateway IP address/port holder 16.

Step S35:

The packet transfer TCP connection manager 18 instructs the communication destination terminal address/port negotiator 19 to send a Notification message with respect to the port 23 of the address 192.168.0.2 from the TCP connection at the port WW to the port XX of the address 15.23.1.2.

Step S36:

The communication destination terminal address/port negotiator 19 then sends the Notification message with respect to the port 23 of the address 192.168.0.2 from the TCP connection at the port WW to the port XX of the address 15.23.1.2.

Step S40:

Based on the processing in STEP S33, the TCP connection is established also in the router B.

Step S41:

The TCP unit 11 supplies the Notification message received through the port XX to the packet transfer unit 17. Since the supplied message is a first packet other than SYN, ACK transmitted from the sending port WW, the packet transfer unit 17 regards the message as a Notification message, and transfers it to the packet transfer TCP connection manager 18.

Step S42:

The packet transfer TCP connection manager 18 then establishes a TCP connection between the address and the port (the port 23 of the address 192.168.0.2) indicated by the Notification message.

Step S43:

The packet transfer TCP connection manager 18 instructs the communication destination terminal address/port negotiator 19 to send a TCP SYN message to the port WW of the address 34.56.10.4. The communication destination terminal address/port negotiator 19 sends the SYN message via the already established TCP connection.

Step S44:

The communication destination terminal address/port negotiator 19 writes, in the communication destination terminal•gateway IP address/port holder 16, an entry having the destination address and the port (192.168.0.2:23) and the source address and the port (10.0.0.1:ZZ) of the established TCP connection, the source address and the port (34.36.10.4:WW) and the destination address and the port (15.23.1.2:XX) of the TCP connection through which the Notification message has been sent, and an on communication permission flag. Then, the processing goes to a branch (1) shown in FIG. 15.

The process will be described below with reference to FIG. 15.

Step S50:

The communication destination terminal address/port negotiator 19 notifies the packet transfer TCP connection manager 18 that a connection to the port 23 of the address 192.168.0.2 is established via the TCP connection from the port XX of the address 15.23.1.2 to the port WW.

Step S51:

The packet transfer TCP connection manager 18 searches the communication destination terminal•gateway IP address/port holder 16 using “34.56.10.4/WW;15.23.1.2:XX” as a key, and detects that the TCP connection to the sending terminal is between the address 192.168.0.1:YY and the address 10.0.0.1:23.

Step S52:

The packet transfer TCP connection manager 18 establishes a TCP connection between the address 192.168.0.1:YY and the address 10.0.0.1:23 through the TCP unit 11.

Step S53:

The packet transfer TCP connection manager 18 changes, to an on state, the communication permission flag of the entry “192.168.0.2//34.56.10.4:WW;15.23.1.2:XX//192.168.0.1:YY;10.0.0.1:23//x”.

According to the above process, a TCP connection is established between the router A and the router B.

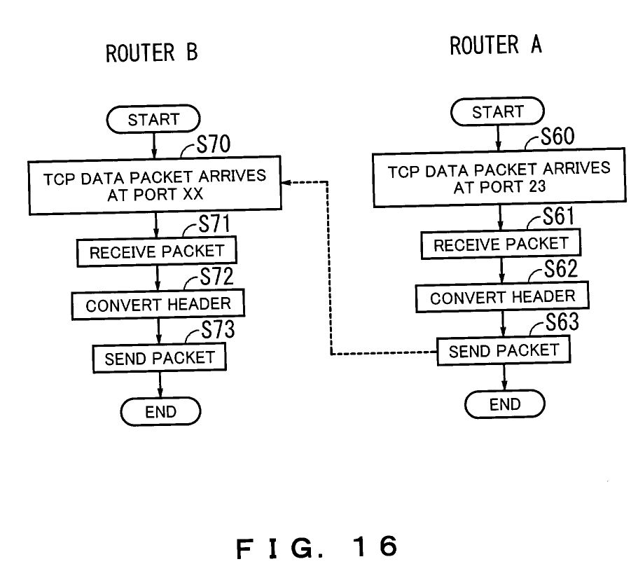

A process of transferring packets using the TCP connected thus established will be described below with reference to FIG. 16. By way of example, a process of transferring packets between the router A and the router B will be described below.

Step S60:

A TCP DATA packet whose destination address is 10.0.0.1 and whose destination port is 23 arrives at the router A from the terminal A.

Step S61:

Since the address 10.0.0.1 is registered in the receivable IP address holder 10a, the IP unit 10 of the router A receives the packet and transfers the packet to the packet transfer unit 17 through the TCP unit 11.

Step S62:

The packet transfer unit 17 searches the communication destination terminal•gateway IP address/port holder 16, converts 10.0.0.1:23, which represents the destination IP address and the port information, into 15.23.1.2:XX, and also converts 192.168.0.1:YY, which represents the source IP address and the port information, into 34.56.10.4:WW. The packet transfer unit 17 does not convert the datagram in the packet.

Step S63:

The packet transfer unit 17 sends the packet whose addresses have been converted through the TCP unit 11.

Step S70:

The TCP DATA packet arrives from the router A at the port XX of the router B.

Step S71:

The TCP unit 11 of the router B receives the DATA packet that has arrived at the port XX, and transfers the DATA packet to the data transfer unit 17.

Step S72:

The packet transfer unit 17 searches the communication destination terminal•gateway IP address/port holder 16, converts 15.23.1.2:XX, which represents the destination IP address and the port information, into 192.168.0.2:23, and also converts 192.168.0.1:YY, which represents the source IP address and the port information, into 10.0.0.1:ZZ. The packet transfer unit 17 does not convert the datagram in the packet.

Step S73:

The packet transfer unit 17 sends the packet whose addresses have been converted to the PC-B.home-a.com (the terminal C) through the TCP unit 11.

According to the above process, the packet can be transferred using the TCP connection.

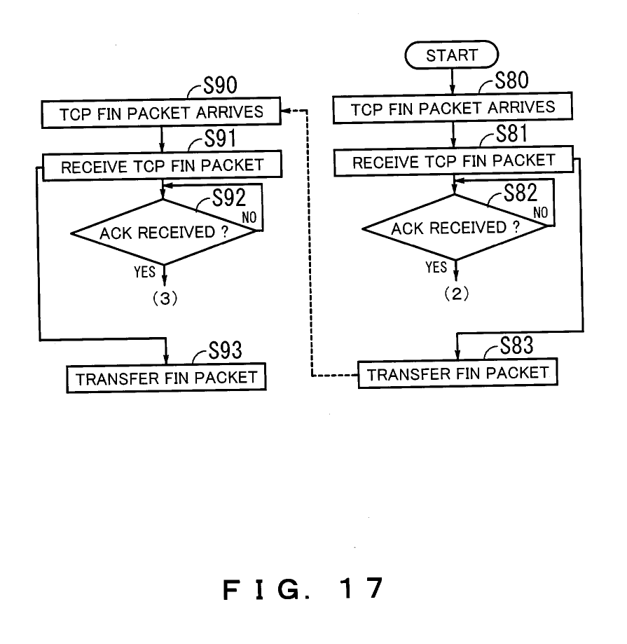

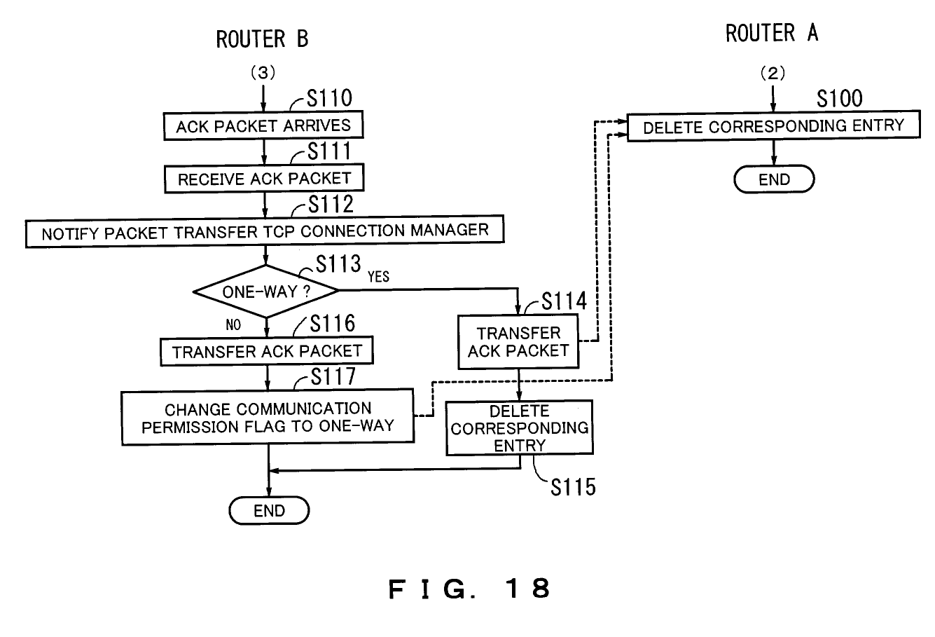

A process carried out by the router A and the router B at the time a TCP connection is finished will be described below with reference to FIGS. 17 and 18. First, the process will be described below with reference to FIG. 17.

Step S80:

A TCP FIN packet whose destination address is 10.0.0.1 and whose destination port is 23 arrives at the router A from the terminal A.

Step S81:

Since the address 10.0.0.1 is registered in the receivable IP address holder 10a, the IP unit 10 of the router A receives the packet and transfers the packet to the packet transfer unit 17 through the TCP unit 11. Then, the processing in STEP S83 and the processing in STEP S82 are carried out concurrent with each other.

Step S82:

The packet transfer TCP connection manager 18 searches the communication destination terminal•gateway IP address/port holder 16, and determines whether there is received an ACK message in response to the FIN packet from the connection whose destination IP address and port information is represented by 34.56.10.4:WW and whose source IP address and port information is represented by 15.23.1.2:XX or not. If the ACK message is received, then the processing proceeds to a branch (2) in FIG. 18. Otherwise, the processing in STEP S82 is repeated.

Step S83:

The packet transfer unit 17 searches the communication destination terminal•gateway IP address/port holder 16, converts 10.0.0.1:23, which represents the destination IP address and the port information, into 15.23.1.2:XX, and also converts 192.168.0.1:YY, which represents the source IP address and the port information, into 34.56.10.4:WW. The packet transfer unit 17 does not convert the datagram in the packet, and transfers the packet to the router B through the TCP unit 11.

Step S90:

The TCP FIN packet arrives from the router A at the port XX of the router B.

Step S91:

The TCP unit 11 transfers the FIN packet received through the port XX to the packet transfer unit 17. The packet transfer unit 17 notifies the packet transfer TCP connection manager 18 that the FIN packet has arrived from the TCP connection whose destination IP address and port information is represented by 15.23.1.2:XX and whose source IP address and port information is represented by 34.36.10.4:WW. Then, the packet transfer unit 17 carries out the processing in STEP S92 and the processing in STEP S93 concurrent with each other.

Step S92:

The packet transfer TCP connection manager 18 searches the communication destination terminal•gateway IP address/port holder 16, and determines whether there is received an ACK message in response to the FIN packet from the connection whose destination IP address and port information is represented by 10.0.0.1:ZZ and whose source IP address and port information is represented by 192.168.0.2:23 or not. If the ACK message is received, then the processing proceeds to a branch (3) in FIG. 18. Otherwise, the processing in STEP S92 is repeated.

Step S93:

The packet transfer unit 17 searches the communication destination terminal•gateway IP address/port holder 16, converts 15.23.1.2:XX, which represents the destination IP address and the port information, into 192.168.0.2:23, and also converts 34.56.10.4:WW, which represents the source IP address and the port information, into 10.0.0.1:ZZ. The packet transfer unit 17 does not convert the datagram in the packet, and transfers the packet to PC-B.home-a.com through the TCP unit 11.

The process will be described below with reference to FIG. 18.

Step S100:

The ACK packet is transferred and the entry in the communication destination terminal•gateway IP address/port holder 16 is changed or deleted in the same operation as the router B, i.e., the processing in STEP S110 through STEP S117 to be described below.

Step S110:

The ACK packet arrives at the router B.

Step S111:

Since the address 10.0.0.1 contained in the ACK packet is registered in the receivable IP address holder 10a, the IP unit 10 of the router B receives the ACK packet and transfers the ACK packet to the packet transfer unit 17 through the TCP unit 11.

Step S112:

The packet transfer unit 17 notifies the packet transfer TCP connection manager 18 that the ACK packet has arrived from the TCP connection whose destination IP address and port information is represented by 10.0.0.1:ZZ and whose source IP address and port information is represented by 192.168.0.2:23.

Step S113:

The packet transfer TCP connection manager 18 identifies the ACK packet as the ACK packet which has been waited for in STEP S92 shown in FIG. 17. The packet transfer TCP connection manager 18 searches the communication destination terminal•gateway IP address/port holder 16, and determines whether the communication permission flag in the corresponding entry is on (◯) or indicates a one-way connection (Δ). If the communication permission flag indicates a one-way connection, then the processing goes to STEP S114. Otherwise, the processing goes to STEP S116.

Step S114:

The ACK packet is transferred to the router B according to the already described process.

Step S115:

The packet transfer TCP connection manager 18 deletes the corresponding entry stored in the communication destination terminal•gateway IP address/port holder 16. At the same time, the packet transfer TCP connection manager 18 notifies the receivable IP address holder 10a of stopping receiving the dummy address described as the changed destination IP address in the entry, and returns the dummy address to the dummy IP address pool unit 15.

Step S116:

The ACK packet is transferred to the router B according to the already described process.

Step S117:

The packet transfer TCP connection manager 18 changes the communication permission flag stored in the communication destination terminal•gateway IP address/port holder 16 to a value representing a one-way connection.

According to the above process, it is possible to finish a TCP connection.

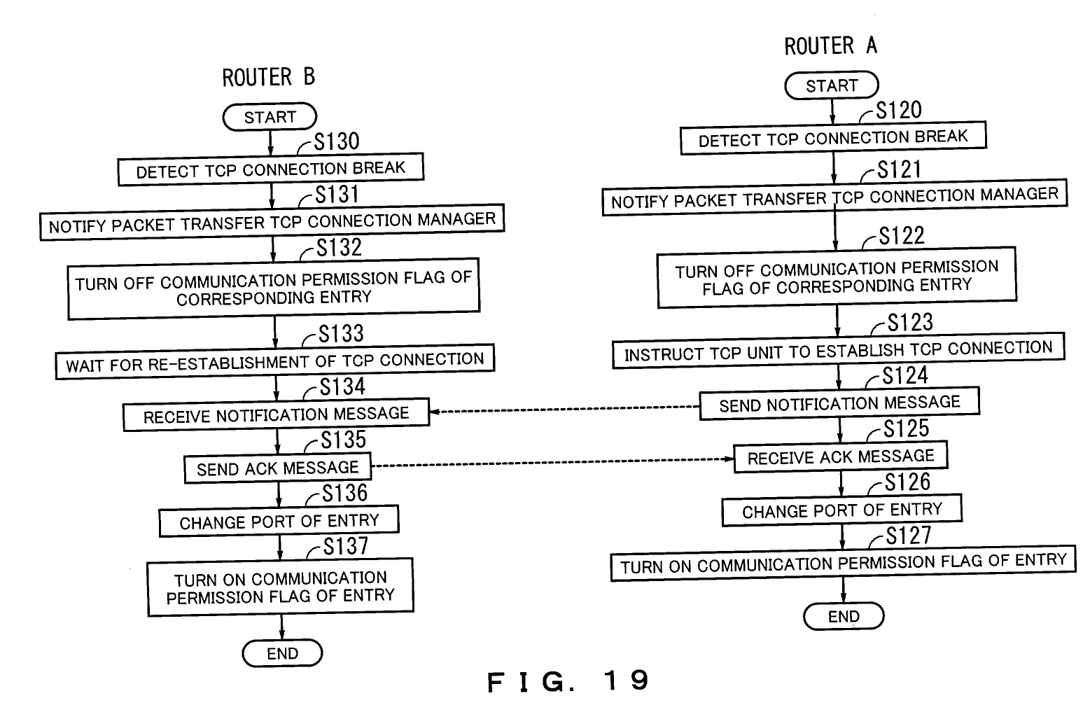

A process of restoring a TCP connection when the TCP connection is broken will be described below with reference to FIG. 19. By way of example, a process of restoring a TCP connection between the router A and the router B when the TCP connection is broken will be described below.

Step S120:

The TCP unit 11 of the router A detects that a TCP connection between the router A and the router B is broken.

Step S121:

The TCP unit 11 of the router A notifies the packet transfer TCP connection manager 18 of the IP addresses and port numbers of the both ends (the router A and the router B) of the broken connection.

Step S122:

The packet transfer TCP connection manager 18 of the router A searches the communication destination terminal•gateway IP address/port holder 16 using the data received from the TCP unit 11 as a key, and turns off the communication permission flag in an entry from the result of the search.

Step S123:

Since the “destination terminal” field is not NULL, the packet transfer TCP connection manager 18 of the router A instructs the TCP unit 11 to establish a TCP connection between itself and the port XX of the router B.

Step S124:

The router A sends a Notification message according to the already mentioned process.

Step S125:

The router A receives a ACK message according to the already mentioned process.

Step S126:

The packet transfer TCP connection manager 18 rewrites the changed source port number in the entry into a new port number (VV).

Step S127:

The packet transfer unit 17 turns on the communication permission flag.

Step S130:

The TCP unit 11 of the router B detects a break of the TCP connection between the router B and the router A.

Step S131:

The TCP unit 11 of the router B notifies the packet transfer TCP connection manager 18 of the IP addresses and port numbers of the both ends (the router A and the router B) of the broken connection.

Step S132:

The packet transfer TCP connection manager 18 of the router B searches the communication destination terminal•gateway IP address/port holder 16 using the data received from the TCP unit 11 as a key, and turns off the communication permission flag in an entry from the result of the search.

Step S133:

Since the “destination terminal” field is not NULL, the packet transfer TCP connection manager 18 of the router B waits for the re-establishment of a connection from the router A.

Step S134:

The router B receives the Notification message sent in STEP S124.

Step S135:

The router B sends an ACK message in response to the Notification message according to the already mentioned process.

Step S136.

The packet transfer TCP connection manager 18 rewrites the source port number prior to being changed in the corresponding entry in the communication destination terminal•gateway IP address/port holder 16 into a new port number (VV).

Step S137:

The packet transfer TCP connection manager 18 turns on the communication permission flag in the corresponding entry in the communication destination terminal•gateway IP address/port holder 16.

According to the above process, it is possible to restore a TCP connection between the router A and the router B when the TCP connection is broken.

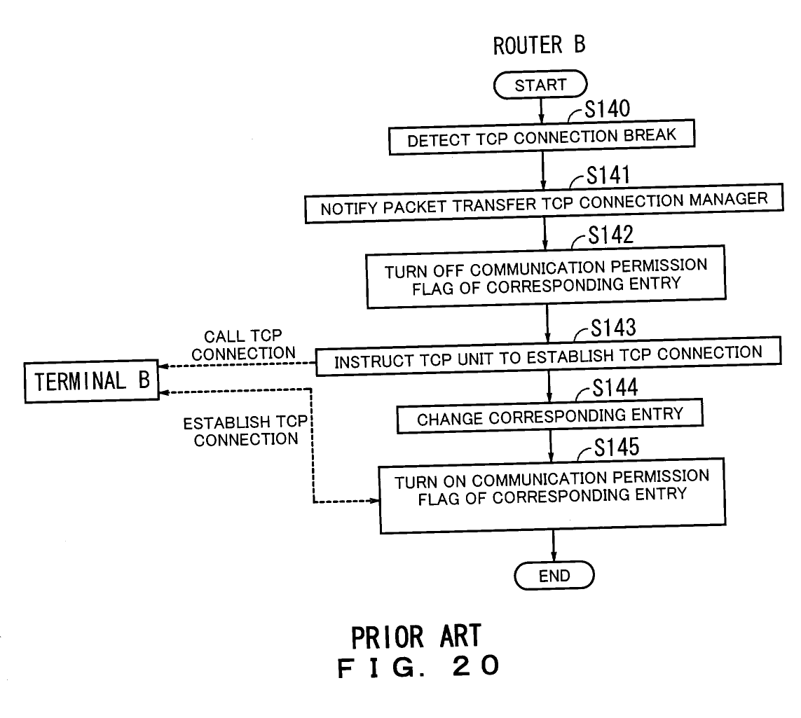

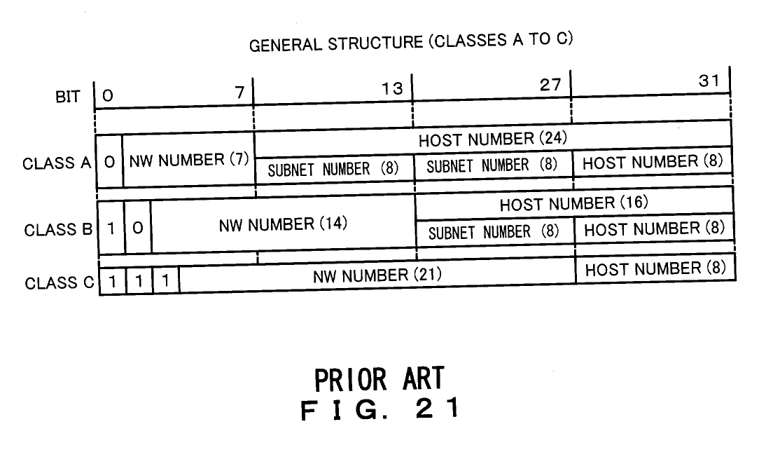

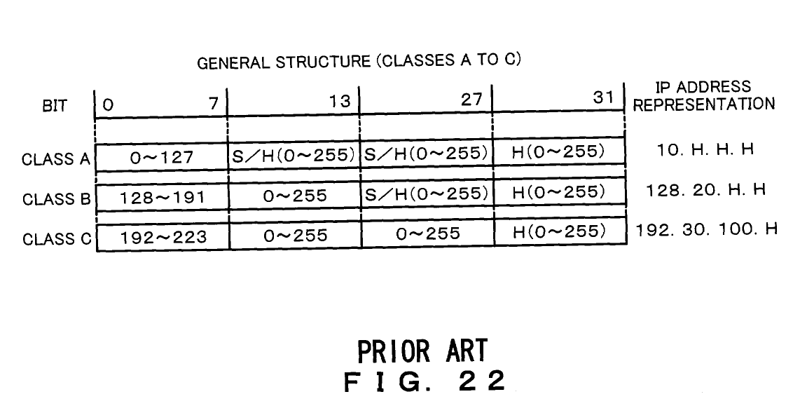

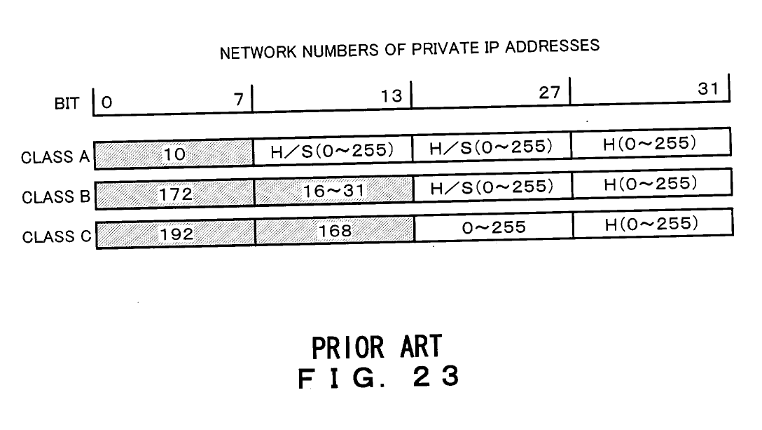

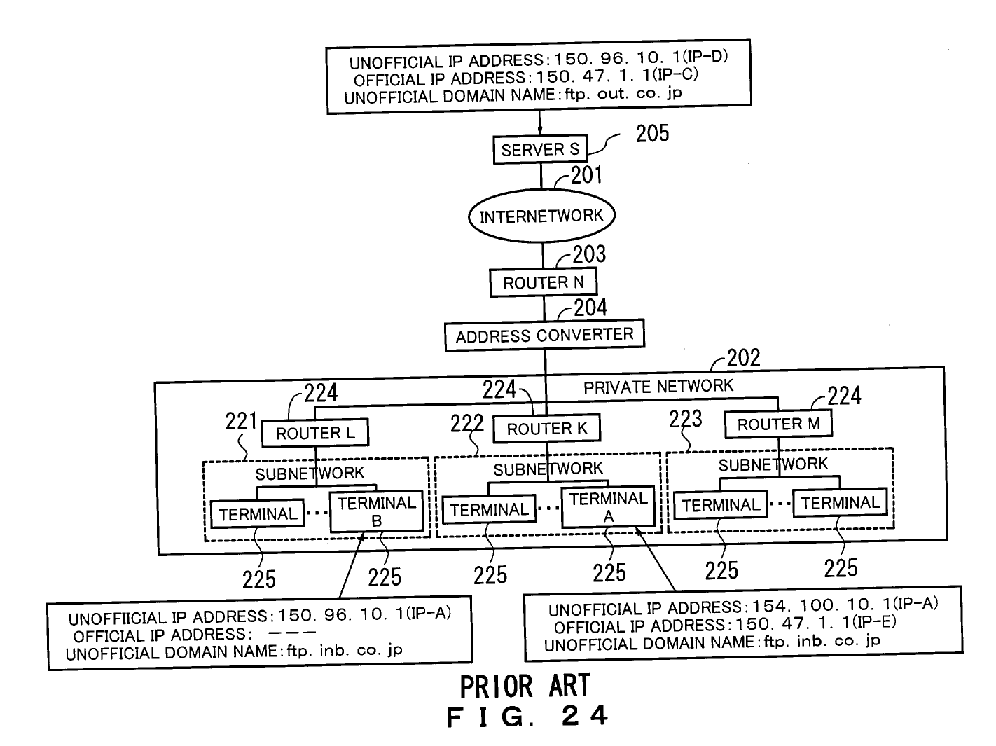

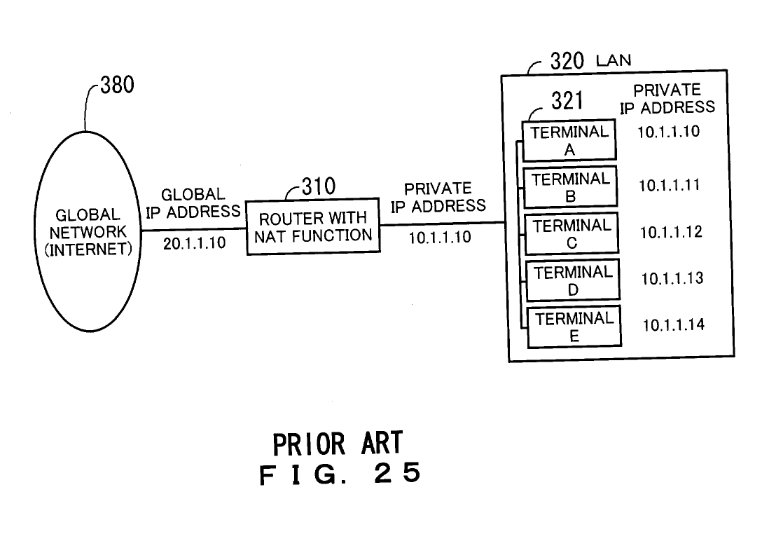

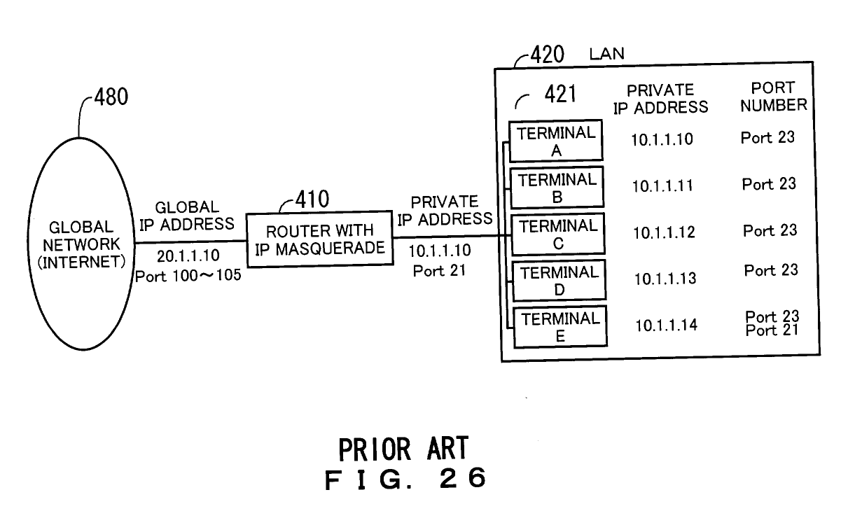

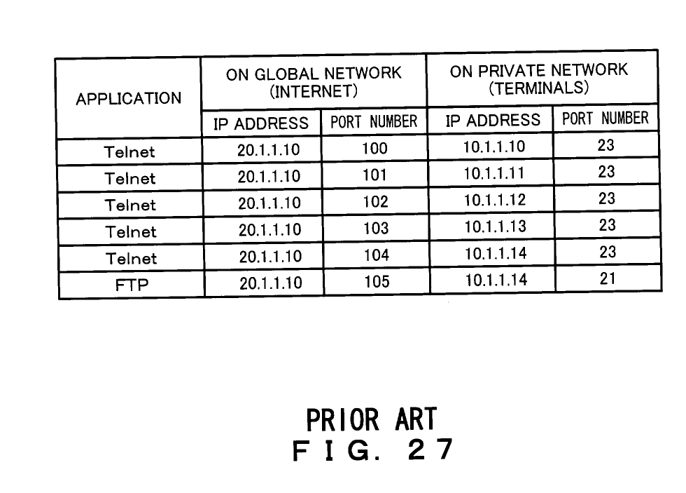

A process of restoring a connection between the router B and the terminal C when the connection is broken will be described below with reference to FIG. 20.

Step S140:

The TCP unit 11 of the router B detects that a TCP connection between the router B and the router C is broken.

Step S141:

The TCP unit 11 of the router B notifies the packet transfer TCP connection manager 18 of the IP addresses and port numbers of the both ends (the router B and the terminal C) of the broken connection.

Step S142:

The packet transfer TCP connection manager 18 of the router B searches the communication destination terminal•gateway IP address/port holder 16 using the data received from the TCP unit 11 as a key, and turns off the communication permission flag in an entry from the result of the search.

Step S143:

The packet transfer TCP connection manager 18 of the router B instructs the TCP unit 11 to establish a TCP connection between itself and the port 23 of the terminal C. As a result, the TCP connection is called.

Step S144:

The packet transfer TCP connection manager 18 of the router B changes the corresponding entry in the communication destination terminal•gateway IP address/port holder 16, i.e., rewrites the source port number into a new port number (UU).

Step S145:

The packet transfer TCP connection manager 18 of the router B turns on the communication permission flag in the corresponding entry in the communication destination terminal•gateway IP address/port holder 16. As a result, the TCP connection is established between the router B and the terminal C.

According to the above process, it is possible to restore a TCP connection between the router B and the terminal C when the TCP connection is broken.

According to the present invention, as described above, since a unique FQDN (Fully Qualified Domain Name: a host name comprising a host name, a dot, and a domain name, e.g., “www.fts.com”) is assigned to a terminal on a private address network, a terminal can have a unique identifier irrespective of whether the terminal belongs to a private address network or a global address network. As a result, though private address networks use respective overlapping address spaces, it is possible to unify terminals on those private address networks.

According to the present invention, furthermore, DNS servers for private address networks which do not belong to a tree of DNS servers on a global address network are provided in association with the respective private address networks, and are accessible from the global address network. Therefore, a name resolution for a private address can be achieved via the global address network.

According to the present invention, moreover, a TCP connection in a private address network and a TCP connection in a global address network are separately established by a router (address converter) at the boundary between the private address network and the global address network, and the router maps, i.e., exchanges information between, the TCP connections, thereby making it possible to accomplish a TCP connection from the global address network to the private address network.

According to the present invention, as described above, there is provided a communication apparatus belonging to a first network which is made up of communication apparatus having addresses of a first type, respectively, and having a second network which is made up of terminals governed thereby and having addresses of a second type, respectively, the communication apparatus comprising managing means for managing names given to terminals belonging to a network governed by another communication apparatus in association with a name given to the other communication apparatus, and means responsive to the reception of a name given to a terminal with which to communicate from one of the terminals, for outputting a request for an address resolution to a corresponding communication apparatus determined by the managing means. With this arrangement, it is possible to assign a unique identifier to a terminal irrespective of whether the terminal belongs to a private address network or a global address network.

According to the present invention, as described above, there is also provided a network system having a fist network which is made up of communication apparatus having addresses of a first type, respectively, and a second network which is made up of terminals governed by a communication apparatus and having addresses of a second type, respectively, the communication apparatus comprising first managing means for managing addresses of terminals governed thereby in association with names given to the terminals, and second managing means for managing the names of the terminals in association with the communication apparatus which manages the addresses of the terminals, the second managing means comprising means, responsive to a communication request from a terminal governed thereby, for determining another communication apparatus to solve an address of a terminal with which to communicate, the first means comprising means for resolving the address in the other communication apparatus. With this arrangement, it is possible to assign a unique identifier to a terminal and perform communications based on the unique identifier.

According to the present invention, as described above, there is further provided a network system having a global address network having nodes with respective unique addresses, a private address network having nonunique addresses, and an address converter for converting addresses for transmitting data between the global address network and the private address network, the address converter comprising means for assigning unique names to respective nodes of the private address network and managing the unique names, and means, responsive to an inquiry about a name from a node belonging to the global address network or another private address network, for acquiring and indicating a corresponding private address. Each of the nodes can have a unique identifier irrespective of whether the node belongs to the private address network or the global address network.

According to the present invention, there is also provided a network system having a global address network having nodes with respective unique addresses, a private address network having nonunique addresses, a first address converter for converting addresses in the global address network, and a second address converter for converting addresses between the private address network and the global address network, the first address converter and the second address converter having means for establishing connections independently of each other and exchanging information about the connections with each other to send and receive data between the global address network and the private address network. Therefore, it is possible to establish a connection from the global address network to the private address network.

The foregoing is considered as illustrative only of the principles of the present invention. Further, since numerous modification and changes will readily occur to those skilled in the art, it is not desired to limit the invention to the exact construction and applications shown and described, and accordingly, all suitable modifications and equivalents may be regarded as falling within the scope of the invention in the appended claims and their equivalents.

What is claimed is:

1. A communication apparatus belonging to a first network which is made up of communication apparatus having addresses of a first type, respectively, and having a second network which is made up of terminals governed thereby and having addresses of a second type, respectively, said communication apparatus comprising:
managing means for managing names given to terminals belonging to a network governed by another communication apparatus in association with a name given to the other communication apparatus; and
means responsive to the reception of a name given to a terminal with which to communicate from one of the terminals, for outputting a request for an address resolution to a corresponding communication apparatus determined by said managing means.

2. The communication apparatus according to claim 1, further comprising:
managing means for managing addresses of terminals governed thereby in association with names of the terminals; and
means responsive to a request from said other communication apparatus for an address resolution with respect to a terminal governed thereby, for resolving an address with said managing means and notifying said other communication apparatus of the resolved address.

3. The communication apparatus according to claim 2, further comprising:
means responsive to the reception from said other communication apparatus of a notification of a resolved address in response to a request for an address resolution, for managing the resolved address in association with a dummy address converted into an address of said second type which is not used as an address of a terminal of the network governed by the other communication apparatus; and
means for notifying a terminal which has requested communications of the converted address.

4. The communication apparatus according to claim 3, further comprising:
means for converting a dummy address into an address of said other communication apparatus if a packet having the notified dummy address is received from the terminal which has requested communications.

5. A network system having a fist network which is made up of communication apparatus having addresses of a first type, respectively, and a second network which is made up of terminals governed by a communication apparatus and having addresses of a second type, respectively, said communication apparatus comprising:
first managing means for managing addresses of terminals governed thereby in association with names given to the terminals; and
second managing means for managing the names of the terminals in association with the communication apparatus which manages the addresses of the terminals;
said second managing means comprising means, responsive to a communication request from a terminal governed thereby, for determining another communication apparatus to solve an address of a terminal with which to communicate, said first means comprising means for resolving the address in said other communication apparatus.

6. A network system having a global address network having nodes with respective unique addresses, a private address network having nonunique addresses, and an address converter for converting addresses for transmitting data between the global address network and the private address network, said address converter comprising means for assigning unique names to respective nodes of said private address network and managing the unique names, and means responsive to an inquiry about a name from a node belonging to said global address network or another private address network, for acquiring and indicating a corresponding private address.

7. The network system according to claim 6, further comprising:
another address converter connected to a sending terminal and having registered therein the unique names assigned to the respective nodes.

8. The network system having a global address network having nodes with respective unique addresses, a private address network having nonunique addresses, a first address converter for converting addresses in said global address network, and a second address converter for converting addresses between said private address network and said global address network, said first address converter and said second address converter comprising means for establishing connections independently of each other and exchanging information about the connections with each other to send and receive data between said global address network and said private address network.

9. The network system according to claim 8, wherein said first address converter comprises means for notifying said second address converter of the information of a connection when said connection is established by a sending terminal.

10. The network system according to claim 9, wherein said first address converter comprises means for notifying said sending terminal of a dummy address which is different from an actual private address of a receiving terminal.

11. The network system according to claim 10, wherein said dummy address comprises an address having different network class from the actual private address of said receiving terminal.

12. The network system according to claim 9, wherein said second address converter comprises means for, when a connection to a receiving terminal is broken, re-establishing the connection by referring to the information of the connection from said first address converter.

13. The network system according to claim 9, wherein said first address converter comprises means for, when a connection to said second address converter is broken, newly establishing a connection to said second address converter by referring to the information of a receiving terminal, and notifying said second address converter of the information of the newly established connection, and said second address converter comprises means for updating the connection based on the information of the newly established connection.

14. The network system according to claim 9, wherein said first address converter and said second address converter have means for holding information indicative of a state of a connection, and transferring data based on the information held thereby.

15. The network system according to claim 9, wherein said information indicative of the state of a connection comprises information representing either the connection being established, the connection established only in one way, or a communication capability.

16. An address converter for converting addresses for transmitting data between a global address network having nodes with respective unique addresses and a private address network having nonunique addresses, said address converter comprising means for assigning unique names to respective nodes of said private address network and managing the unique names, and means responsive to an inquiry about a name from a node belonging to said global address network or another private address network, for acquiring and indicating a corresponding private address.

17. An address converter for converting addresses in a global address network, said address converter being connected to a network system having the global address network having nodes with respective unique addresses, a private address network having nonunique addresses, and another address converter for converting addresses between said global address network and said private address network, said address converter comprising means for establishing connections independently of said other address converter and exchanging information about the connections with said other address converter to send and receive data between said global address network and said private address network.

18. The address converter according to claim 17, further comprises means for notifying said other address converter of the information of the connection when said connection is established by a sending terminal.

19. The address converter according to claim 18, further comprising means for notifying said sending terminal of a dummy address which is different from an actual private address of a receiving terminal.

20. The address converter according to claim 19, wherein said dummy address comprises an address having different network class from the actual private address of said receiving terminal.
